(19) United States
(12) Patent Application Publication
(10) Pub. No.: US 2026/0330184 A1
(43) Pub. Date: Oct. 22, 2026

(54) SYSTEM

(71) Applicant: SoftBank Group Corp., Tokyo (JP)

(72) Inventor: Ryouji NISHIMOTO, Tokyo (JP)

(73) Assignee: SoftBank Group Corp., Tokyo (JP)

(21) Appl. No.: 19/646,634

(22) Filed: Apr. 14, 2026

(30) Foreign Application Priority Data
Apr. 22, 2025 (JP) 2025-070635

(51) Int. Cl. G06N 3/042; G06F 11/00; G06N 3/0455; G06N 3/08; G06Q 10/0635; H04L 49/20

(52) U.S. Cl. CPC G06N 3/042; G06F 11/004; G06N 3/0455; G06N 3/08; H04L 49/20; G06F 2201/81; G06Q 10/0635

(57) ABSTRACT

The present invention relates to a system that integrates a wide variety of data relating to employees, analyzes a turnover risk and engagement with high accuracy using generative AI, and automatically proposes an optimal follow-up measure and an organization improvement measure for individual employees and the entire organization. The system centrally manages data such as work status, evaluation, questionnaires, project progress, communication history, system usage, welfare programs, SNS activity, environment sensors, and industry trends, identifies a risk factor by utilizing natural language processing and machine learning by the generative AI, and visualizes and notifies the risk factor in real time to a management team and a human resources department, thereby realizing maximization of organization performance and prevention of human resource outflow.

### CROSS-REFERENCE TO RELATED APPLICATION

The present application claims priority to and incorporates by reference the entire contents of Japanese Patent Application No. 2025-070635 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that, in mid-sized to large enterprises, a turnover risk and a decrease in engagement of employees cannot be grasped at an early stage, and an outflow of excellent human resources, stagnation of organization performance, and loss of productivity and creativity due to a decrease in motivation are likely to occur; in addition, since a wide variety of distributed data such as work status, evaluation data, questionnaire results, project progress, communication history, internal system usage status, welfare program usage, SNS activity, office environment sensor data, and industry trends are individually managed, it is difficult to utilize these data in an integrated and secure manner, and accurate human resources strategies and management decisions cannot be made promptly; furthermore, due to the spread of remote work, conventional face-to-face management methods are no longer effective, and grasping the status of employees and communication tend to be insufficient, so that although early discovery of organizational issues and optimal measure proposals by a data-driven approach are required, conventional technology has not been able to sufficiently realize this.

### SUMMARY OF THE INVENTION

Means for solving the problem is to configure a system comprising: a data integration unit configured to collect and integrate a wide variety of data relating to employees; an AI analysis unit configured to analyze a turnover risk and an engagement level for each employee with high accuracy by utilizing generative AI using the integrated data; and a measure proposal unit configured to automatically propose an optimal follow-up measure and an organization improvement measure for individual employees and the entire organization based on an analysis result by the AI analysis unit, and further visualize and notify information in real time to a management team and a human resources department, wherein the data integration unit is configured to centrally integrate a plurality of types of data relating to the employees, such as work status data, evaluation data, questionnaire results, project progress information, communication history, internal system usage status, welfare program usage history, internal and external SNS activity trends, office environment sensor data, and industry trend data, by linking the data with a common key such as an employee ID, and automatically execute preprocessing such as missing value imputation, outlier removal, quantification, category conversion, and natural language processing; the AI analysis unit is configured to calculate a turnover risk score and an engagement score for each employee by a machine learning model using the generative AI with the integrated data as an input, and further identify and extract factors contributing to each score in order of importance; and the measure proposal unit is configured to automatically select and propose a specific follow-up measure such as an individual interview, career path redesign, workload adjustment, welfare program usage promotion, a team building measure, and mentoring introduction for individual employees based on the scores and a factor analysis result, visualize a turnover risk distribution and an engagement distribution for the entire organization in real time, extract an issue in a specific department or group, and notify the management team and the human resources department of the issue.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

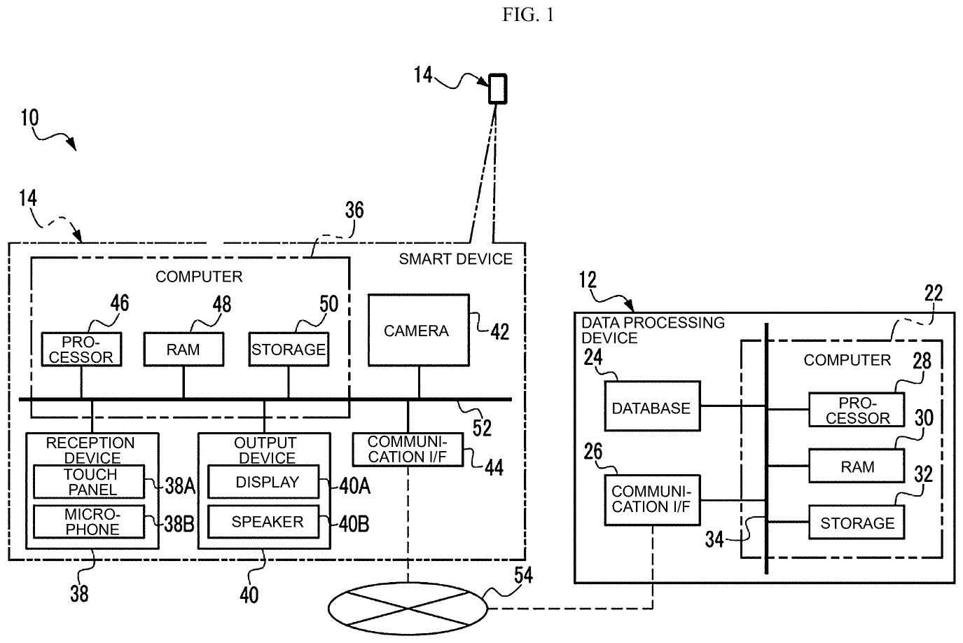

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

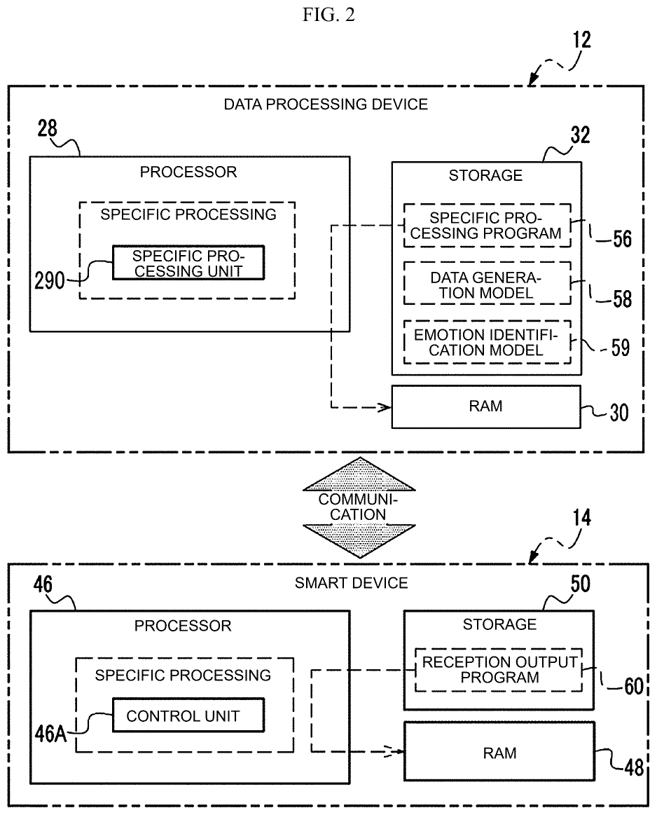

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

An embodiment for carrying out the present invention will be described in extreme detail and comprehensively, taking a system composed of a server and a terminal as an example, with specific functions of each component, a processing flow, a utilization method of generative AI, role sharing between the server and the terminal, and various specific examples. Specifically, the present system adopts a distributed computing architecture. The present system constructs a hybrid inference engine integrating a large language model and a deep learning model on the server. The present system executes a feature extraction process in a high-dimensional vector space. The present system returns a response in milliseconds to an asynchronous request from the terminal. The present system dramatically improves calculation efficiency by parallelizing data processing. The present system eliminates conventional manual data aggregation work. The present system calculates a prediction score by a forward propagation operation of a multi-layer neural network. The present system is applied to use cases such as personnel management and organization consulting. The present system realizes data-driven organization management.

The system of the present invention is configured to include a data integration unit, an AI analysis unit, a measure proposal unit, and a learning/optimization unit on a server side, and a user interface unit on a terminal side. The server cooperates with various internal and external databases and external systems, and bears high-load processing such as collection, integration, analysis, measure generation, and learning optimization of a huge amount of data. The terminal provides an interface for various users such as a management team, a human resources person in charge, a site manager, and an employee himself/herself to operate and browse a dashboard, a notification screen, a report screen, and the like, and performs bidirectional communication with the server. Specifically, the present system implements each processing unit as an independent container based on a microservice architecture. The present data integration unit asynchronously acquires data in a lightweight data description language format from an external system via an application programming interface gateway. The present AI analysis unit operates on a parallel computing cluster using an image processing semiconductor. The present AI analysis unit includes a large language model based on a transformer architecture. The present measure proposal unit searches for an optimal solution using a reinforcement learning algorithm. The present learning/optimization unit dynamically updates a weight parameter of a neural network using a gradient descent method. The present server communicates with the terminal using a resource-oriented web communication protocol or a bidirectional communication protocol. The present terminal dynamically renders the received data using a front-end framework. With this configuration, the present system can flexibly scale out calculation resources on the server side. The present system centralizes high-load tensor operations on the server side. The present system minimizes a processing load on the terminal side. The present system reduces consumption of a communication band. The present system enables real-time data visualization. The present system is applied to use cases such as employee monitoring and health management in a large-scale organization.

The data integration unit operates on the server, and automatically and periodically collects and integrates a wide variety of data relating to employees. For example, from an attendance management system, clock-in/out times, overtime hours, leave acquisition status, the number of late arrivals/early departures, the latest paid leave utilization rate, and the like are acquired, and from a personnel evaluation system, an evaluation score, a promotion history, an evaluator comment, a goal setting/achievement status, a 360-degree evaluation result, and the like are acquired. From a questionnaire system, a satisfaction survey, a stress check, a career orientation survey, a free-text answer regarding a workplace environment, and the like are acquired, and from a project management system, a task completion rate, a milestone achievement status, the number of projects in charge, a change in role, a communication frequency in a project, the number of delay occurrences, and the like are acquired. From a mail/chat/meeting system, the number of sent/received mails, the number of meeting participations, a chat usage frequency, the number of remarks in a meeting, the number of chat groups, the number of reactions, meeting recording/minutes data, and the like are acquired. From a business application, an application usage log, a login history, a usage time zone, a type of used function, an error occurrence frequency, the number of account locks, and the like are acquired. From a welfare program system, a health checkup consultation history, a cafeteria plan usage status, an internal event participation history, a mental health consultation usage history, a childcare/nursing care leave acquisition status, the number of internal cafe usages, and the like are acquired. From an internal SNS and an external SNS, the number of posts, the number of reactions, comment content, industry community participation, the number of followers, an emotional tendency of post content, an industry trend transmission status on the external SNS, and the like are acquired. From an office environment sensor, temperature, humidity, air quality, illuminance, a noise level, a CO2 concentration, a seat utilization rate, an in-office movement history, and the like are acquired. From an industry information provision service, a turnover rate of the entire industry, an economic index, human resource liquidity of a peer company, a new project trend in the industry, a compensation level change, and the like are acquired. Furthermore, in a remote work environment, an online meeting participation frequency during telework, the number of remarks in a chat group, a stress tendency in the remote environment, a business application usage status, a VPN connection time, a usage frequency of a remote work tool, a work environment questionnaire result during telework, and the like are also acquired. Specifically, the present data integration unit asynchronously receives streaming data from each data source using a distributed message queue. The present data integration unit temporarily stores the received raw data in a buffer on a memory. The present data integration unit converts structured data and unstructured data into a unified multi-dimensional tensor format. The present data integration unit inputs text data to a natural language processing model. The present natural language processing model generates a word embedding vector. The present data integration unit converts voice data into an acoustic feature vector. The present data integration unit samples sensor data as a time-series numerical array. The present data integration unit maps these heterogeneous data to the same high-dimensional vector space. The present data integration unit assigns a time stamp and a unique identifier to each data point. The present data integration unit stores the data in a hybrid storage combining a relational database and a non-relational database. By this processing, the present system eliminates data silos. The present system ensures the quality of input data for a subsequent machine learning model. The present system significantly reduces calculation time required for data preprocessing. The present system is applied to use cases such as smart office management and employee engagement analysis.

The data integration unit centrally stores these diverse data in a database by linking the data with a common key such as an employee ID, an email address, an affiliated department, and a project ID. For example, for an employee A, a transition of overtime hours in the latest six months, content of an evaluation interview, a progress status of a project in charge, a remark frequency on the internal SNS, a health checkup consultation history, an application usage status during telework, the number of remote meeting participations, an industry transmission status on the external SNS, and the like are all integrated in chronological order. After data acquisition, preprocessing such as missing value imputation (for example, imputing an unentered questionnaire item with an average value or a median value), outlier removal (for example, detecting and excluding an extreme number of logins or unnatural overtime hours), quantification and category conversion (for example, converting a free-text description of a questionnaire into a positive/negative score by generative AI, and converting a department name or a job title into a category value), natural language processing (for example, performing sentiment analysis on an interview record or SNS post content by the generative AI to extract an index of stress or satisfaction), and smoothing and trend extraction of time-series data (for example, a moving average of overtime hours or detection of a rapid change point) is automatically executed. In particular, the generative AI is essential for analyzing free-text data and unstructured data, and for example, extracts a negative emotion or a sign of an engagement decline from a comment such as “I do not feel rewarded in my recent work” or “My relationship with my boss is becoming weak”, quantifies it, and reflects it in the integrated data. Specifically, the present data integration unit models a complex relationship between entities using a graph database. The present data integration unit executes a K-nearest neighbor algorithm or a multiple imputation method in the missing value imputation. The present data integration unit executes an isolation forest algorithm in the outlier removal. The present data integration unit converts a categorical variable into a multi-dimensional binary vector by one-hot encoding. The present data integration unit executes sentiment analysis of text data using a large language model. Input data to the present large language model is a tokenized text sequence. The number of dimensions of the present input data is, for example, 512 tokens. A specific example of the present input data includes a text string indicating being exhausted due to too much workload. Another specific example includes a text string indicating being glad to be able to challenge a new project. Output data from the present large language model is a probability distribution vector indicating a polarity of an emotion. A specific example of the present output data includes a numerical vector of a negative probability of 0.85 and a positive probability of 0.15. Another specific example includes a numerical vector of a negative probability of 0.10 and a positive probability of 0.90. The present data integration unit applies a Kalman filter to time-series data to remove noise. The present data integration unit extracts a trend component of a time series using an autoregressive integrated moving average model. The present data integration unit combines the extracted feature amounts to generate a single feature vector. The present feature vector is input to the subsequent AI analysis unit. By this processing, the present system extracts an implicit feature hidden in unstructured data as explicit numerical data. The present system dramatically improves prediction accuracy of the machine learning model. The present system is applied to use cases such as mental health care and personnel evaluation support.

The AI analysis unit operates on the server, and calculates a turnover risk score and an engagement score for each employee by a machine learning model utilizing generative AI with the integrated data as an input. For example, a classification model using data of past retirees as teacher data and a regression model using an engagement survey result as teacher data are automatically generated and optimized by the generative AI, and a “probability of leaving the company within the next half year” and a “current engagement level” are output as a score from 0 to 1 for each employee. The generative AI is also utilized for feature selection of a model, hyperparameter optimization, ensemble learning, automatic selection of an anomaly detection algorithm, and the like. Furthermore, the generative AI analyzes factors contributing to each score by explainable AI technology such as a SHAP value and LIME, and extracts factors of a risk and low engagement in order of importance, such as a “rapid increase in overtime hours”, a “role reduction in a project”, a “decrease in SNS remark frequency”, a “decrease in welfare program usage”, a “decrease in remote meeting participation frequency”, and “non-consultation of a health checkup”. For example, for an employee B, “overtime hours increased 1.5 times in the latest two months”, “remarks on the internal SNS halved”, “non-consultation of a health checkup”, “chat remarks during remote work drastically decreased”, and the like are identified as main causes of an increase in the turnover risk. Furthermore, the AI analysis unit automatically executes a risk/engagement distribution, a time-series change, clustering of an abnormal value, inter-departmental comparison, comparison with an industry benchmark, and the like for the entire organization or in units of departments. Specifically, the present AI analysis unit constructs an ensemble model combining a gradient boosting decision tree and a long short-term memory network. Input data to the present AI analysis unit is a multi-dimensional tensor including a time-series feature amount of each employee. The number of dimensions of the present input data is, for example, a matrix in which a 128-dimensional feature amount continues for 24 time steps. A specific example of the present input data includes a numerical array indicating monthly overtime hours for the past six months. Another specific example includes a numerical array indicating a transition of an emotion score for the past one year. Output data from the present AI analysis unit is a continuous value score indicating a turnover probability and a continuous value score indicating an engagement level. A specific example of the present output data includes a floating-point number of a turnover risk score of 0.78. Another specific example includes a floating-point number of an engagement score of 0.45. The present AI analysis unit calculates a loss of the classification model using a cross-entropy error function. The present AI analysis unit calculates a loss of the regression model using a mean squared error function. The present AI analysis unit updates a weight of a network using a backpropagation algorithm. The present AI analysis unit executes a feature contribution calculation algorithm based on game theory to calculate a marginal contribution of each feature amount. The present AI analysis unit sorts the feature amounts in descending order based on the calculated contribution value. The present AI analysis unit identifies a higher-ranked feature amount as a risk factor. The present output result is input to the subsequent measure proposal unit. By this processing, the present system presents a judgment basis of AI, which tends to be a black box, in a form understandable to humans. The present system ensures transparency and reliability of prediction. The present system is applied to use cases such as talent management and organization development consulting.

The measure proposal unit operates on the server, and automatically proposes an optimal follow-up measure and an organization improvement measure for individual employees and the entire organization based on an output result of the AI analysis unit. The generative AI also learns a past measure implementation history and effect data, and automatically selects a measure estimated to have the highest effect for each employee. For example, for an employee C with a high turnover risk and low engagement, “implementation of an individual interview by an immediate supervisor”, “career path redesign”, “workload adjustment”, “guidance on mental health support”, “welfare program usage promotion”, “recommendation of internal event participation”, “mentoring introduction”, and the like are proposed, and for an employee D with high engagement but a high turnover risk, “review of a compensation and evaluation system”, “assignment to a new project”, “recommendation for an internal award”, “taking a skill-up training”, and the like are recommended. For an employee E whose communication amount is decreasing under a remote work environment, “an increase in frequency of online interviews”, “holding a virtual lunch party”, “mental health support for remote work”, “telework environment improvement support”, and the like are proposed. For the entire organization, a turnover risk distribution and an engagement distribution are visualized in real time, issues such as “high-risk employees are concentrated in a specific department”, “there is a department where engagement tends to decline”, “there is a group with a low welfare program usage rate”, and “a stress score increases in a remote work department” are extracted, and measures such as “company-wide work style reform”, “communication activation event”, “expansion of a welfare program system”, “enhancement of a remote work support measure”, and “promotion of a cross-departmental project” are proposed to the management team and the human resources department. The generative AI is also utilized for automatic generation of a measure proposal text, effect prediction after measure implementation, prioritization of measures, customization of a measure (for example, fine-tuning proposal content according to a personality tendency or a past reaction of an employee), and the like. Specifically, the present measure proposal unit solves a Markov decision process using a deep reinforcement learning algorithm. Input data to the present measure proposal unit is a state vector of an employee and a past measure history vector. The number of dimensions of the present input data is, for example, a 256-dimensional continuous value vector. A specific example of the present input data includes a state vector including a turnover risk score of 0.8 and an engagement score of 0.3. Another specific example includes a binary flag indicating the presence or absence of a mentoring system implemented in the past. Output data from the present measure proposal unit is a probability distribution of expected reward values for a plurality of candidate measures. A specific example of the present output data includes a score array indicating a recommendation degree of 0.9 for an individual interview and a recommendation degree of 0.7 for workload adjustment. Another specific example includes a score array indicating a recommendation degree of 0.85 for a compensation review. The present measure proposal unit dynamically synthesizes a specific proposal text using a transformer-based natural language generation model. The present measure proposal unit formats the generated proposal text as structured data. The present output result is transmitted to the subsequent user interface unit. By this processing, the present system automatically generates a personalized measure optimized for an individual state instead of a uniform measure. The present system significantly streamlines a decision-making process of a human resources person in charge. The present system is applied to use cases such as employee retention improvement and organizational culture improvement.

The learning/optimization unit operates on the server, continuously learns a performance change (for example, a turnover risk decrease, an engagement improvement, a work productivity improvement, a project progress improvement, a communication amount increase, and the like) after measure implementation, and optimizes content and timing of a measure proposal. For example, when a turnover risk significantly decreases in an employee group for which “individual interview+workload adjustment” was implemented in the past, the same measure is preferentially proposed to an employee having a similar tendency. Conversely, when a specific measure does not show an effect, the generative AI analyzes the reason and automatically selects another measure. Furthermore, implementation timing and a combination of measures (for example, “career interview+mentoring introduction”) are also optimized. Specifically, the present learning/optimization unit sequentially updates a parameter of a model using an online learning algorithm. Input data to the present learning/optimization unit is a state vector before measure implementation, an identifier of the implemented measure, and a difference vector indicating a state change after measure implementation. The number of dimensions of the present input data is, for example, a 512-dimensional combined vector. A specific example of the present input data includes a numerical set of a turnover risk of 0.8 before measure implementation, a measure identifier of an individual interview, and a turnover risk of 0.5 after implementation. Another specific example includes a numerical set of an engagement of 0.4 before measure implementation, a measure identifier of taking a training, and an engagement of 0.45 after implementation. Output data from the present learning/optimization unit is an updated weight matrix of a neural network. A specific example of the present output data includes a multi-dimensional array of floating-point numbers indicating a connection strength between respective nodes. Another specific example includes an update difference value of an action value function in reinforcement learning. The present learning/optimization unit calculates a future expected reward using a Bellman equation. The present learning/optimization unit approximates a value function by temporal difference learning. The present learning/optimization unit applies an epsilon-greedy method to control a trade-off between exploration and exploitation. The present output result is directly reflected in an inference process in the next measure proposal unit. By this processing, the present system self-adaptively evolves in response to an environmental change or an individual characteristic change. The present system maximizes a success probability of a long-term measure. The present system is applied to use cases such as an autonomous human resources agent and a dynamic resource allocation system.

The user interface unit operates on the terminal, and enables users such as a management team, a human resources person in charge, a site manager, and an employee himself/herself to browse and operate an analysis result and a measure proposal transmitted from the server on a dashboard, a notification screen, a report screen, and the like. For example, the management team uses a dashboard capable of overlooking a risk/engagement distribution of the entire organization, a tendency by department, comparison with an industry benchmark, and a transition of a measure implementation history and an effect, the human resources person in charge uses a screen capable of confirming a risk factor and a measure proposal of an individual employee, a past response history, and details of a measure effect, the site manager uses a screen capable of confirming an issue and a recommended measure of his/her own department, a communication status in the department, and risk analysis linked with project progress, and the employee himself/herself uses a screen capable of browsing and inputting his/her own engagement transition, a recommended support measure, a past feedback history, and goal setting and a career desire by self-declaration. Operation content from the terminal (for example, feedback on measure implementation, a questionnaire answer, self-declaration content, and a reaction to a measure proposal) is transmitted to the server, and is reflected in real time in subsequent AI analysis and measure proposals. Specifically, the present user interface unit is implemented as a single-page application. The present user interface unit speeds up screen drawing using a virtual document object model. The present user interface unit parses data received from the server and stores the data in a state management container. The present user interface unit dynamically updates a graph or a chart on a screen using data binding technology. The present user interface unit asynchronously captures a user's click event or scroll event. The present user interface unit transmits the captured event data as a payload to a communication endpoint of the server. The present user interface unit renders a clustering result of high-dimensional data as a three-dimensional scatter plot using a web-based graphics library. The present user interface unit adopts a responsive design to adapt to various screen resolutions. By this processing, the present system conceals a network delay and provides smooth operability. The present system reduces a user's cognitive load and promotes intuitive data understanding. The present system is applied to use cases such as a management dashboard and an employee self-service portal.

In addition, from the viewpoint of security and privacy protection, data encryption, access authority management, anonymization processing, audit log recording, and the like are also strictly implemented on the server side. For example, personal information is encrypted and stored, and only minimum necessary information is decrypted and displayed at the time of analysis or visualization. Access authority is finely set according to a role of a user, and the management team can browse company-wide data, but the site manager can browse only data of his/her own department, and the employee himself/herself can browse only his/her own data. Specifically, the present system encrypts stored data in units of blocks using an advanced encryption standard algorithm. The present system encrypts data on a communication path using a transport layer security protocol. The present system implements a role-based access control model to dynamically verify a user's authority. The present system combines attribute-based access control to realize finer-grained access control. The present system executes a k-anonymization algorithm and an l-diversity algorithm to reduce a personal identification risk in a dataset. The present system adds Laplace noise to aggregated data using differential privacy technology. The present system unidirectionally converts a password or an identifier using a hash function. The present system appends an audit log including a time stamp, a network address, and a user identifier to a non-volatile storage for all communication requests. By this processing, the present system ensures tamper resistance against internal fraud or an external cyberattack. The present system technically ensures compliance with privacy protection laws and regulations. The present system is applied to a human resources data management use case in an environment where high security is required, such as a financial institution or a medical institution.

As described above, the embodiment of the present invention realizes the data integration unit, the AI analysis unit, the measure proposal unit, and the learning/optimization unit on the server, and realizes the user interface unit on the terminal, thereby comprehensively and safely integrating a wide variety of data relating to employees, realizing advanced analysis using generative AI, automatic proposal of an optimal measure, and continuous learning and optimization of a measure effect, and enabling real-time and individually optimal information provision and maximization of organizational performance for all of the management team, the human resources department, the site manager, and the employee himself/herself. For example, when a turnover risk of an employee increases, an alert notification and a specific follow-up measure are immediately proposed, an effect after measure implementation is automatically evaluated and learned, and is reflected in subsequent proposals. For example, for an employee whose communication amount has decreased in a remote work environment, a proposal of an online interview or a virtual event is automatically made, and a change in a stress score or an engagement score after implementation is visualized in real time. For example, when a company-wide engagement decline is detected, a proposal of a company-wide measure and its effect prediction are automatically presented to the management team. By realizing such a series of processing by server-terminal cooperation with the generative AI as a core, it is possible to provide a human resource management support system having unprecedented comprehensiveness, immediacy, and individual optimality. Specifically, the present system connects a plurality of neural network models as a pipeline. The present system constructs a real-time event-driven architecture using a data stream processing engine. The present system enables lightweight inference processing on the terminal side by using edge computing technology together. The present system performs learning by sharing only a weight of a model without transmitting raw data to the server using federated learning technology. The present system acquires a useful representation from unlabeled data using self-supervised learning. The present system analyzes a topology of a communication network between employees using a graph neural network. The present system integrates these advanced computer science methods. By this processing, the present system eliminates conventional manual heuristic judgment. The present system establishes an objective and quantitative decision-making process based on data. The present system minimizes processing latency while maximizing utilization efficiency of calculation resources. The present system is applied to use cases such as a next-generation human capital management platform and an integrated enterprise resource planning system.

### System Configuration

The system according to the present embodiment comprises a data integration unit, an AI analysis unit, a measure proposal unit, a learning/optimization unit, and a user interface unit. The data integration unit has a function of automatically and periodically collecting and integrating a wide variety of data relating to employees. For example, clock-in/out times, overtime hours, leave acquisition status, the number of late arrivals/early departures, the latest paid leave utilization rate, and the like can be acquired from an attendance management system, and an evaluation score, a promotion history, an evaluator comment, a goal setting/achievement status, a 360-degree evaluation result, and the like can be acquired from a personnel evaluation system. Furthermore, a satisfaction survey, a stress check, a career orientation survey, a free-text answer regarding a workplace environment, and the like can be acquired from a questionnaire system, and a task completion rate, a milestone achievement status, the number of projects in charge, a role change, a communication frequency within a project, the number of delay occurrences, and the like can be acquired from a project management system. In addition, the number of sent/received emails, the number of meeting participations, a chat usage frequency, the number of remarks in a meeting, the number of chat groups, the number of reactions, meeting recording/minutes data, and the like can be acquired from an email/chat/meeting system, and an application usage log, a login history, a usage time zone, a type of used function, an error occurrence frequency, the number of account locks, and the like can be acquired from a business application. A health checkup consultation history, a cafeteria plan usage status, an internal event participation history, a mental health consultation usage history, a childcare/nursing care leave acquisition status, the number of internal cafe usages, and the like can be acquired from a welfare system, and the number of posts, the number of reactions, comment content, industry community participation, the number of followers, an emotional tendency of post content, an industry trend transmission status on an external SNS, and the like can be acquired from an internal SNS and an external SNS. Furthermore, temperature, humidity, air quality, illuminance, a noise level, a CO2 concentration, a seat utilization rate, an in-office movement history, and the like can be acquired from an office environment sensor, and a turnover rate of the entire industry, an economic index, human resource liquidity of peers, a new project trend in the industry, a compensation level change, and the like can be acquired from an industry information provision service. In a remote work environment, an online meeting participation frequency during telework, the number of remarks in a chat group, a stress tendency in the remote environment, a business application usage status, a VPN connection time, a usage frequency of a remote work tool, a work environment questionnaire result during telework, and the like can also be acquired. The data integration unit centrally stores these diverse data in a database by linking the data with a common key such as an employee ID, an email address, an affiliated department, and a project ID, and automatically executes preprocessing such as missing value imputation, outlier removal, quantification, category conversion, natural language processing, and smoothing and trend extraction of time-series data. Specific examples of a prompt sentence to be read by the generative AI include “Quantify a positive/negative emotion score from 0 to 1 from the following content of a free-text column of an employee questionnaire, and extract a sign of stress or engagement. Input: ‘I do not feel rewarded in my recent work. My relationship with my boss is becoming weak.’” and the like. Specifically, the present data integration unit implements a data pipeline engine that automates extraction, transformation, and loading processes. The present data integration unit dynamically analyzes a schema definition of each data source and automatically generates a mapping rule. The present data integration unit executes named entity extraction from unstructured text using a large language model. Input data to the present large language model is a text sequence of natural language. The number of dimensions of the present input data is a variable-length token array. A specific example of the present input data includes a text stating that the user is anxious about being transferred to a new department from next month. Another specific example includes a text stating that the user is not convinced by a decision made at yesterday's meeting. Output data from the present large language model is a structured object including a pair of an extracted entity and an emotion score related thereto. A specific example of the present output data includes a numerical value of an anxiety score of 0.9 for an entity transfer. Another specific example includes a numerical value of a dissatisfaction score of 0.8 for an entity meeting. The present data integration unit inserts these output data into a designated column of a relational database. The present data integration unit applies a fast Fourier transform to time-series data to analyze a frequency component. By this processing, the present system projects data of diverse formats into a single computable vector space. The present system completely eliminates a human cost required for data cleansing. The present system is applied to use cases such as construction of an integrated human resource database and development of a people analytics infrastructure.

The AI analysis unit has a function of calculating a turnover risk score and an engagement score for each employee by a machine learning model utilizing generative AI with the integrated data as an input. For example, a classification model using data of past retirees as teacher data and a regression model using an engagement survey result as teacher data can be automatically generated and optimized by the generative AI, and a “probability of leaving the company within the next half year” and a “current engagement level” can be output as a score from 0 to 1 for each employee. The AI analysis unit also utilizes the generative AI for feature selection of a model, hyperparameter optimization, ensemble learning, automatic selection of an anomaly detection algorithm, and the like. Furthermore, the AI analysis unit can analyze factors contributing to each score by explainable AI technology, and extract factors of a risk and low engagement, such as a “rapid increase in overtime hours”, a “role reduction in a project”, a “decrease in SNS remark frequency”, a “decrease in welfare program usage”, a “decrease in remote meeting participation frequency”, and “non-consultation of a health checkup”, in order of importance. For example, factors such as “for an employee B, overtime hours have increased 1.5 times in the latest two months, remarks on the internal SNS have halved, a health checkup has not been consulted, and chat remarks during remote work have drastically decreased” are identified. The AI analysis unit also automatically executes a risk/engagement distribution, a time-series change, clustering of abnormal values, an inter-departmental comparison, a comparison with an industry benchmark, and the like for the entire organization or each department. Specific examples of a prompt sentence to be read by the generative AI include “Calculate a turnover risk score and an engagement score from 0 to 1 based on the following employee integrated data, and extract three major risk factors. Input: ‘increase in overtime hours, decrease in SNS remarks, non-consultation of health checkup, project role reduction’” and the like. Specifically, the present AI analysis unit executes dimensional compression of high-dimensional data using an autoencoder. The present AI analysis unit inputs a compressed latent variable vector to a multilayer perceptron. Input data to the present AI analysis unit is a normalized numerical matrix. The number of dimensions of the present input data is, for example, a 64-dimensional latent feature vector. A specific example of the present input data includes a vector including a normalized value of 0.8 for overtime hours and a normalized value of 0.2 for an SNS remark frequency. Another specific example includes a vector including a health checkup consultation flag of 0 and a project role score of 0.4. Output data from the present AI analysis unit is a probability value in a range of 0 to 1 via a sigmoid function. A specific example of the present output data includes a numerical value of a turnover probability of 0.82. Another specific example includes a numerical value of an engagement probability of 0.35. The present AI analysis unit automatically searches for a hyperparameter such as a learning rate and a batch size using a Bayesian optimization algorithm. The present AI analysis unit assigns a weight to an important time step in time-series data using an attention mechanism. The present AI analysis unit sets an alert flag when the output score exceeds a predetermined threshold. The present output result is transferred to the subsequent measure proposal unit and user interface unit. By this processing, the present system models a complex non-linear relationship to realize highly accurate prediction. The present system early detects a minute sign that is difficult to notice by human intuition. The present system is applied to use cases such as an early retirement prevention program and motivation maintenance of a high performer.

The measure proposal unit has a function of automatically proposing an optimal follow-up measure and an organization improvement measure for individual employees and the entire organization based on an output result of the AI analysis unit. The generative AI also learns a past measure implementation history and effect data, and automatically selects a measure estimated to have the highest effect for each employee. For example, for an employee C with a high turnover risk and low engagement, “implementation of an individual interview by an immediate boss”, “career path redesign”, “workload adjustment”, “guidance of mental health support”, “welfare program usage promotion”, “recommendation of internal event participation”, “mentoring introduction”, and the like can be proposed. For an employee D with high engagement but a high turnover risk, “review of a compensation and evaluation system”, “assignment to a new project”, “recommendation for an internal award”, “taking a skill-up training”, and the like can be recommended. For an employee E whose communication amount is decreasing under a remote work environment, “increase in frequency of online interviews”, “holding of a virtual lunch party”, “mental health support for remote work”, “telework environment improvement support”, and the like can be proposed. For the entire organization, issues such as “high-risk employees are concentrated in a specific department”, “there is a department where engagement tends to decrease”, “there is a group with a low welfare program usage rate”, and “a stress score increases in a remote work department” are extracted, and measures such as “company-wide work style reform”, “communication activation event”, “expansion of a welfare system”, “enhancement of a remote work support measure”, and “promotion of a cross-departmental project” can be proposed to the management team and the human resources department. Specific examples of a prompt sentence to be read by the generative AI include “Propose three optimal follow-up measures based on the following turnover risk score and engagement score of an employee, and major risk factors. Input: ‘turnover risk 0.85, engagement 0.32, factors: increase in overtime, decrease in SNS remarks, non-consultation of health checkup’” and the like. Specifically, the present measure proposal unit models a dependency relationship and a constraint condition between measures using a knowledge graph. Input data to the present measure proposal unit is a profile vector of an employee and a weight vector of a risk factor. The number of dimensions of the present input data is, for example, a 128-dimensional context vector. A specific example of the present input data includes a vector including a turnover risk of 0.85 and an overtime increase flag of 1. Another specific example includes a vector including an engagement of 0.32 and an SNS remark decrease flag of 1. Output data from the present measure proposal unit is an identifier list of recommended measures and an execution priority score of each measure. A specific example of the present output data includes a numerical pair of a priority of 0.95 for a measure identifier interview. Another specific example includes a numerical pair of a priority of 0.88 for a measure identifier workload adjustment. The present measure proposal unit calculates a cosine similarity to extract a measure that succeeded in a past similar case. The present measure proposal unit inputs the generated measure list to a rule-based filtering engine to exclude a measure that violates employment regulations of a company. The present output result is passed to a subsequent workflow engine to automatically start an approval process. By this processing, the present system instantly searches for an optimal solution from a huge combination space of measures. The present system eliminates variation in measures due to personal judgment. The present system is applied to use cases such as provision of an individualized employee experience and automation of organization development.

The learning/optimization unit has a function of continuously learning a performance change after implementation of a measure, and optimizing content and timing of a measure proposal. For example, when a turnover risk significantly decreases in an employee group for which an “individual interview+workload adjustment” was implemented in the past, the same measure is preferentially proposed to an employee having a similar tendency. Conversely, when a specific measure does not show an effect, the generative AI analyzes the reason and automatically selects another measure. Implementation timing and a combination of measures (for example, “career interview +mentoring introduction”) are also optimized. For example, a prompt sentence such as “When a ratio of a decrease in a turnover risk is high among employees for whom a measure A was implemented in the past six months, preferentially propose the measure A to an employee having a similar profile” can be given to the generative AI. Specifically, the present learning/optimization unit dynamically adjusts a balance between exploration and exploitation of a measure using a bandit algorithm. Input data to the present learning/optimization unit is a measure execution log and a time-series tensor indicating a subsequent state change. The number of dimensions of the present input data is, for example, a 12-dimensional vector indicating a monthly change for the past 12 months. A specific example of the present input data includes a numerical value indicating a turnover risk decrease amount of 0.3 after implementation of the measure A. Another specific example includes a numerical value indicating an engagement improvement amount of 0.1 after implementation of a measure B. Output data from the present learning/optimization unit is an updated probability distribution of an expected effect for each measure. A specific example of the present output data includes a numerical value of a success probability of 0.75 for the measure A. Another specific example includes a numerical value of a success probability of 0.40 for the measure B. The present learning/optimization unit updates a policy gradient so as to maximize an expected reward using a gradient ascent method. The present learning/optimization unit automates a test framework for evaluating a plurality of measure variations in parallel. The present output result is overwritten and saved as a weight parameter of an inference model of the measure proposal unit. By this processing, the present system closes a feedback loop to realize continuous accuracy improvement. The present system automatically adapts to a characteristic of an organization that changes over time. The present system is applied to use cases such as data-driven personnel measure evaluation and maximization of return on investment.

The user interface unit has a function of enabling a user such as a management team, a human resources person in charge, a site manager, and an employee himself/herself to browse and operate an analysis result and a measure proposal transmitted from a server on a dashboard, a notification screen, a report screen, and the like. For example, the management team can use a dashboard capable of overlooking a risk/engagement distribution of the entire organization, a departmental tendency, a comparison with an industry benchmark, and a transition of a measure implementation history and an effect, the human resources person in charge can use a screen capable of confirming a risk factor and a measure proposal of an individual employee, a past response history, and details of a measure effect, the site manager can use a screen capable of confirming an issue and a recommended measure of his/her own department, a communication status within the department, and a risk analysis linked with project progress, and the employee himself/herself can use a screen capable of browsing and inputting his/her own engagement transition, a recommended support measure, a past feedback history, and goal setting and a career desire by self-assessment. Operation content from a terminal (for example, feedback of measure implementation, a questionnaire answer, self-assessment content, and a reaction to a measure proposal) is transmitted to the server, and is reflected in real time in AI analysis and a measure proposal from the next time onward. Specifically, the present user interface unit performs asynchronous communication with the server in accordance with a resource-oriented architecture style. The present user interface unit draws complex multidimensional data as an interactive graph using a data-driven document manipulation library. The present user interface unit expresses a risk concentration degree for each department by a hue gradation using a heat map. The present user interface unit visualizes a communication path between employees with a node and an edge using a network graph. The present user interface unit sanitizes text data acquired from an input form of a user to prevent a cross-site scripting attack. The present user interface unit performs session management and maintenance of an authentication state using a web token. The present user interface unit reads and displays a part of data from a cache even under an offline environment using a service worker. By this processing, the present system presents a huge analysis result in an intuitive format tailored to human cognitive characteristics. The present system dramatically improves a decision-making speed of a user. The present system is applied to use cases such as a support tool for a management strategy meeting and a daily team management dashboard for a manager.

In this way, the system according to the present embodiment comprises the data integration unit, the AI analysis unit, the measure proposal unit, the learning/optimization unit, and the user interface unit, and each unit cooperates with each other to realize integration, analysis, measure generation, learning optimization, and visualization of diverse data with the generative AI as a core, thereby being able to provide a human resource management support system having unprecedented comprehensiveness, immediacy, and individual optimality. Specifically, the present system adopts a high-performance remote procedure call framework for communication between microservices to minimize serialization overhead. The present system dynamically autoscales the number of replicas of each processing unit according to a load using a container orchestration tool. The present system introduces a distributed tracing system to monitor an entire life cycle of a request. The present system caches frequently accessed feature data using an in-memory data grid. The present system constructs a lambda architecture integrating batch processing and stream processing. The present system utilizes a hardware accelerator to improve inference throughput of a deep learning model. By this processing, the present system functions as an autonomous system that fundamentally transforms intellectual productivity of an organization beyond a mere business efficiency improvement tool. The present system maintains response performance on the order of milliseconds even in a large company with tens of thousands of people. The present system is applied to use cases such as integrated human resource management in a global company and a next-generation talent management platform.

### Implementation Steps

### Step 1: Collection and Integration of Multidimensional Employee Data

First, work status data such as clock-in/out times, overtime hours, leave acquisition status, the number of late arrivals/early departures, and a paid leave utilization rate is acquired from an attendance management system, and evaluation data such as an evaluation score, a promotion history, an evaluator comment, a goal setting/achievement status, and a 360-degree evaluation result is acquired from a personnel evaluation system. Furthermore, questionnaire data such as a satisfaction survey, a stress check, a career orientation survey, and a free-text answer regarding a workplace environment is acquired from a questionnaire system, and project progress data such as a task completion rate, a milestone achievement status, the number of projects in charge, a role change, a communication frequency within a project, and the number of delay occurrences is acquired from a project management system. In addition, communication data such as the number of sent/received emails, the number of meeting participations, a chat usage frequency, the number of remarks in a meeting, the number of chat groups, the number of reactions, and meeting recording/minutes data is acquired from an email/chat/meeting system, and system usage data such as an application usage log, a login history, a usage time zone, a type of used function, an error occurrence frequency, and the number of account locks is acquired from a business application. Welfare data such as a health checkup consultation history, a cafeteria plan usage status, an internal event participation history, a mental health consultation usage history, a childcare/nursing care leave acquisition status, and the number of internal cafe usages is acquired from a welfare system, and SNS data such as the number of posts, the number of reactions, comment content, industry community participation, the number of followers, an emotional tendency of post content, and an industry trend transmission status on an external SNS is acquired from an internal SNS and an external SNS. Furthermore, environmental data such as temperature, humidity, air quality, illuminance, a noise level, a CO2 concentration, a seat utilization rate, and an in-office movement history is acquired from an office environment sensor, and industry data such as a turnover rate of the entire industry, an economic index, human resource liquidity of peers, a new project trend in the industry, and a compensation level change is acquired from an industry information provision service. In a remote work environment, an online meeting participation frequency during telework, the number of remarks in a chat group, a stress tendency in the remote environment, a business application usage status, a VPN connection time, a usage frequency of a remote work tool, a work environment questionnaire result during telework, and the like are also acquired, and all these data are centrally integrated into a database by linking the data with a common key such as an employee ID, an email address, an affiliated department, and a project ID. Specifically, in this step, the present system deploys a distributed data collection agent to a node of each data source. The present system combines polling and a webhook to differentially extract only a changed portion of data. The present system publishes the extracted data to a distributed messaging system. The present system activates a consumer process to subscribe to stream data. The present system saves the received data in an object storage in a data lake in a column-oriented storage format. The present system adopts a schema-on-read approach to enable a flexible query of data. The present system couples a plurality of huge tables at high speed on a memory using a hash join algorithm. The present system detects a mismatch of a join key and a duplicate record, and automatically cleanses the data. By this processing, the present system destroys a silo of heterogeneous mixed data and constructs a single reliable information source. The present system reduces latency of data collection to the utmost limit. The present system is applied to use cases such as real-time monitoring of an organizational state and construction of a large-scale data warehouse.

### Step 2: Data Preprocessing and Feature Generation

For the integrated data, preprocessing such as missing value imputation, outlier removal, quantification, category conversion, natural language processing, and smoothing and trend extraction of time-series data is automatically executed. For example, an unentered questionnaire item is imputed with an average value or a median value, and an extreme number of logins or unnatural overtime hours is excluded as an abnormal value. For unstructured data such as a free-text description of a questionnaire, an interview record, and SNS post content, emotion analysis and stress index extraction are performed by natural language processing by the generative AI, and the data is quantified and reflected in the integrated data as a feature. Specific examples of a prompt sentence to be read by the generative AI include “Quantify a positive/negative emotion score from 0 to 1 from the following content of a free-text column of an employee questionnaire, and extract a sign of stress or engagement. Input: ‘I do not feel rewarded in my recent work. My relationship with my boss is becoming weak.’” and the like. Specifically, in this step, the present system executes a series of transformation processes in parallel on a data pipeline. The present system reduces dimensions of high-dimensional data using principal component analysis to eliminate multicollinearity. The present system inputs text data to a bidirectional transformer-based pre-trained language model. Input data to the present language model is an integer array tokenized in units of subwords. The number of dimensions of the present input data is, for example, a one-dimensional tensor with a maximum length of 512. A specific example of the present input data includes an integer array consisting of token identifiers 101, 456, 789, and 102. Another specific example includes an integer array consisting of token identifiers 101, 333, 444, and 102. Output data from the present language model is a dense embedding vector reflecting a context of each token. A specific example of the present output data includes a 768-dimensional floating-point number array. Another specific example includes a softmax distribution of a positive probability of 0.1 and a negative probability of 0.9 output from an emotion classification head. The present system combines these output vectors with other numerical features to construct a final feature matrix. The present system standardizes the feature matrix and scales it to a mean of 0 and a variance of 1. By this processing, the present system improves a convergence speed of a machine learning model. The present system acquires a robust feature representation resistant to noise. The present system is applied to use cases such as text mining and sentiment analysis.

### Step 3: Turnover Risk and Engagement Analysis by Generative AI

With the preprocessed integrated data as an input, a turnover risk score and an engagement score for each employee are calculated by a machine learning model utilizing generative AI. For example, a classification model using data of past retirees as teacher data and a regression model using an engagement survey result as teacher data are automatically generated and optimized by the generative AI, and a “probability of leaving the company within the next half year” and a “current engagement level” for each employee are output as a score from 0 to 1. The generative AI is also utilized for feature selection of the model, hyperparameter optimization, ensemble learning, automatic selection of an anomaly detection algorithm, and the like. As a specific example of a prompt sentence to be read by the generative AI, “Based on the following employee integrated data, calculate a turnover risk score and an engagement score from 0 to 1, and extract three major risk factors. Input: ‘increase in overtime hours, decrease in SNS remarks, non-consultation of health checkup, reduction in project role’” and the like can be cited. Specifically, in this step, the present system executes a forward propagation operation using a multi-layer feedforward neural network. Input data to the neural network is a feature matrix generated in the preprocessing step. The number of dimensions of the input data is, for example, a two-dimensional tensor with a batch size of 256 and a feature dimension number of 1024. A specific example of the input data includes a vector including a normalized overtime hours of 0.75 and an emotion score of 0.2. Another specific example includes a vector including a normalized evaluation score of 0.4 and a communication frequency of 0.3. Output data from the neural network is a one-dimensional tensor including a prediction score of each employee. A specific example of the output data includes a scalar value of a turnover probability of 0.88. Another specific example includes a scalar value of an engagement score of 0.42. The present system inserts a dropout layer to suppress overfitting. The present system introduces nonlinearity using a normalized linear function. The present system applies a sigmoid function to an output layer to map a value to a range from 0 to 1. The output result is inserted into a prediction result table of a database. By this processing, the present system automatically learns an interaction of complex features. The present system realizes high prediction accuracy unachievable by conventional methods. The present system is applied to use cases such as predictive people analytics and risk management.

### Step 4: Identification and Explanation of Risk Factors

The generative AI analyzes factors contributing to each score by explainable AI technology, and extracts factors of a risk and low engagement, such as a rapid increase in overtime hours, a reduction in a project role, a decrease in an SNS remark frequency, a decrease in welfare program usage, a decrease in an online meeting participation frequency, and non-consultation of a health checkup, in order of importance. For example, factors such as “for an employee B, overtime hours have increased 1.5 times in the latest two months, remarks on an internal SNS have halved, non-consultation of a health checkup, and chat remarks during telework have drastically decreased” are identified. As a specific example of a prompt sentence to be read by the generative AI, “Based on the following integrated data and score of an employee, extract three main factors of a turnover risk and an engagement decrease, and explain them in order of importance. Input: ‘increase in overtime hours, decrease in SNS remarks, non-consultation of health checkup, reduction in project role’” and the like can be cited. Specifically, in this step, the present system calculates a contribution degree of each input feature to a prediction of the neural network using an integrated gradients algorithm. Input data to the algorithm is a zero vector serving as a baseline and a feature vector of a target employee. The number of dimensions of the input data is, for example, a 1024-dimensional vector pair. A specific example of the input data includes a pair of a baseline vector and a target vector including an overtime hours feature of 0.8. Another specific example includes a pair of a baseline vector and a target vector including an SNS remark frequency feature of 0.2. Output data from the algorithm is a contribution degree vector indicating an integral value of a gradient corresponding to each feature. A specific example of the output data includes a numerical value of a contribution degree score of plus 0.45 for overtime hours. Another specific example includes a numerical value of a contribution degree score of minus 0.30 for an SNS remark frequency. The present system sorts the features based on absolute values of these contribution degree scores. The present system inputs higher-ranked features to a natural language generation model to synthesize an explanatory text understandable by a human. The output result is displayed on a dashboard of a user interface unit. By this processing, the present system solves a black box problem of AI and fosters a user's sense of conviction for a prediction result. The present system strongly supports planning of a specific improvement action. The present system is applied to use cases such as a support tool for a personnel interview and automatic generation of an organization diagnosis report.

### Step 5: Automatic Proposal of Optimal Measure

Based on an output result of the AI analysis unit, the generative AI automatically proposes an optimal follow-up measure and an organization improvement measure for individual employees and the entire organization. For example, for an employee with a high turnover risk and low engagement, “implementation of an individual interview by an immediate supervisor”, “career path redesign”, “workload adjustment”, “guidance of mental health support”, “welfare program usage promotion”, “recommendation of participation in an internal event”, “mentoring introduction”, and the like are proposed, and for an employee with high engagement but a high turnover risk, “review of a compensation and evaluation system”, “assignment to a new project”, “recommendation for an internal award”, “taking a skill-up training”, and the like are recommended. For the entire organization, issues such as “high-risk employees are concentrated in a specific department”, “there is a department where engagement tends to decrease”, “there is a group with a low welfare program usage rate”, and “a stress score increases in a remote work department” are extracted, and measures such as “company-wide work style reform”, “communication activation event”, “expansion of a welfare program system”, “enhancement of a remote work support measure”, and “promotion of a cross-departmental project” are proposed to a management team and a human resources department. As a specific example of a prompt sentence to be read by the generative AI, “Based on the following turnover risk score and engagement score of an employee, and major risk factors, propose three optimal follow-up measures. Input: ‘turnover risk 0.85, engagement 0.32, factors: increase in overtime, decrease in SNS remarks, non-consultation of health checkup’” and the like can be cited. Specifically, the measure proposal unit drives a generative artificial intelligence module based on a large language model. The module adopts a transformer architecture. The present system constructs a multi-dimensional feature vector including a turnover risk score and an engagement score of an employee as input data. The vector is defined as a 256-dimensional floating-point number array. The present system normalizes each score as preprocessing. The present system generates a numerical pair of a turnover risk score of 0.85 and an engagement score of 0.32 as a specific example of the input data. As another specific example, the present system combines a flag variable indicating an increase in overtime hours and a binary value indicating non-consultation of a health checkup into an input tensor. The generative artificial intelligence module calculates a dependency relationship between input tokens using a self-attention mechanism. The module generates a measure text in a natural language format and a probability distribution vector indicating a recommendation degree of each measure as output data. The output value indicates an expected value that each measure reduces a turnover risk of a target employee. As a specific example of the output, the module outputs text data of implementation of an individual interview by an immediate supervisor and a numerical value of a recommendation degree of 0.92. As another specific example, the module outputs text data of workload adjustment and a numerical value of a recommendation degree of 0.88. The present system inputs the output result to a threshold determination module as subsequent processing. The determination module extracts only a measure whose recommendation degree exceeds a predetermined threshold. The present system transmits the extracted measure data to a user interface unit. With this configuration, the present system eliminates a personalized measure planning work by a human. The present system realizes data-driven objective measure selection. The present system exhibits a technical effect of automatically generating an optimal measure in milliseconds while suppressing consumption of calculation resources. The present technology is applicable to use cases such as a personnel management system in a large-scale organization and an employee mental health care platform.

### Step 6: Measure Implementation and Effect Feedback

Via a user interface unit, an analysis result and a measure proposal transmitted from a server are made viewable and operable on a dashboard, a notification screen, a report screen, and the like for a user such as a management team, a human resources person in charge, a site manager, and an employee himself/herself. The user inputs feedback of measure implementation, a questionnaire answer, self-reported content, a reaction to a measure proposal, and the like from a terminal, and transmits them to the server. Thereby, an implementation status of a measure and effect data are collected in real time, and reflected in AI analysis and a measure proposal from the next time onward. Specifically, the user interface unit establishes a connection with an asynchronous communication protocol. The present system packetizes measure proposal data generated on a server side as a payload in a JSON format. The present system transmits the packet to the terminal via a secure communication path. The terminal renders the received data on a graphical user interface. The present system receives a feedback operation from the user as input data. The input data includes a timestamp indicating completion of implementation of a measure, and a reaction score of a five-level evaluation. The present system converts the input data into a format conforming to a schema of a time-series database as preprocessing. As a specific example of the input data, the present system processes a flag indicating completion of implementation of an individual interview and a numerical value of an evaluation score of 4. As another specific example, the present system processes a flag indicating rejection of workload adjustment and a reason code. The present system transfers the input data to a learning/optimization unit on the server. The learning/optimization unit accumulates the received feedback data as teacher data. The present system generates an update completion notification of a database and a next analysis schedule update command as output data. The output value means that state synchronization of the entire system is completed. As a specific example of the output, the present system outputs a status code 200 and an updated employee profile ID. As another specific example, the present system outputs a recalculation request flag. The present system restarts an inference pipeline of an artificial intelligence analysis unit based on the recalculation request flag as subsequent processing. With this configuration, the present system tracks an implementation status of a measure in real time. The present system exhibits a technical effect of automating a feedback loop and realizing continuous accuracy improvement of a machine learning model. The present technology is applicable to use cases such as a dynamic task management system and a real-time employee engagement monitoring platform.

### Step 7: Learning and Optimization of Measure Effect

A learning/optimization unit continuously learns a performance change after implementation of a measure (for example, a decrease in a turnover risk, an improvement in engagement, an improvement in work productivity, an improvement in project progress, an increase in a communication amount, and the like), and optimizes content and timing of a measure proposal. For example, when a turnover risk significantly decreases in an employee group for which “individual interview+workload adjustment” was implemented in the past, the same measure is preferentially proposed to an employee having a similar tendency. Conversely, when a specific measure does not show an effect, the generative AI analyzes a reason thereof, and automatically selects another measure. As a specific example of a prompt sentence to be read by the generative AI, “When a ratio of a decrease in a turnover risk is high among employees for whom a measure A was implemented in the past six months, preferentially propose the measure A to an employee having a similar profile” and the like can be cited. Specifically, the learning/optimization unit drives a neural network implementing a reinforcement learning algorithm. The present system acquires a state vector before implementation of a measure, an identifier of an implemented measure, and a reward vector indicating a state change after implementation of the measure as input data. The state vector is a 128-dimensional tensor including attribute data and various scores of an employee. The present system scales the reward vector to a range from minus 1 to plus 1 as preprocessing. As a specific example of the input data, the present system processes a positive reward value indicating that a turnover risk has decreased by 0.2. As another specific example, the present system processes a zero reward value indicating that an engagement score has not changed. The neural network approximates an action value function for a combination of a state and a measure using a multi-layer perceptron. The present system updates a weight parameter of the network using an error backpropagation method. The present system generates a probability distribution of an updated expected reward value for each measure as output data. The output value means a priority with which each measure is selected in a similar case in the future. As a specific example of the output, the present system outputs a selection probability of 0.75 for a measure A and a selection probability of 0.15 for a measure B. As another specific example, the present system outputs a selection probability of 0.10 for a measure C. The present system feeds back the probability distribution to an inference engine of a measure proposal unit as subsequent processing. The inference engine utilizes the probability distribution as a prior distribution at the time of next measure generation. With this configuration, the present system surpasses a static rule-based proposal system. The present system exhibits a technical effect of dynamically adapting to an environmental change and autonomously maximizing a success probability of a measure. The present technology is applicable to use cases such as a personalized education support system and an optimal action recommendation system in customer relationship management.

### Specific Use Case

For example, a case will be described in which the system of the present invention is introduced into a company with thousands of employees in the information service industry, and visualization of a turnover risk and engagement of all employees and an optimal measure proposal are implemented. First, a data integration unit automatically acquires work status data such as clock-in/out times, overtime hours, leave acquisition status, the number of late arrivals/early departures, and a paid leave utilization rate of each employee from an attendance management system, and acquires evaluation data such as an evaluation score, a promotion history, an evaluator comment, a goal setting/achievement status, and a 360-degree evaluation result from a personnel evaluation system. Furthermore, questionnaire data such as a satisfaction survey, a stress check, a career orientation survey, and a free description answer regarding a workplace environment is acquired from a questionnaire system, and project progress data such as a task completion rate, a milestone achievement status, the number of projects in charge, a change in a role, a communication frequency in a project, and the number of delay occurrences is acquired from a project management system. In addition, communication data such as the number of sent/received emails, the number of meeting participations, a chat usage frequency, the number of remarks in a meeting, the number of chat groups, the number of reactions, and recording/minutes data of a meeting is acquired from an email/chat/meeting system, and system usage data such as an application usage log, a login history, a usage time zone, a type of a used function, an error occurrence frequency, and the number of account locks is acquired from a business application. Welfare program data such as a health checkup consultation history, a cafeteria plan usage status, an internal event participation history, a mental health consultation usage history, a childcare/nursing care leave acquisition status, and the number of internal cafe usages is acquired from a welfare program system, and SNS data such as the number of posts, the number of reactions, comment content, industry community participation, the number of followers, an emotional tendency of post content, and an industry trend transmission status on an external SNS is acquired from an internal SNS and an external SNS. Furthermore, environmental data such as temperature, humidity, air quality, illuminance, a noise level, a CO2 concentration, a seat utilization rate, and an in-office movement history is acquired from an office environment sensor, and industry data such as a turnover rate of the entire industry, an economic index, human resource liquidity of a peer company, a new project trend in the industry, and a compensation level change is acquired from an industry information provision service. Under a remote work environment, an online meeting participation frequency during telework, the number of remarks in a chat group, a stress tendency in a remote environment, a business application usage status, a VPN connection time, a usage frequency of a tool for remote work, a work environment questionnaire result during telework, and the like are also acquired, and all these data are centrally integrated into a database by linking the data with a common key such as an employee ID, an email address, an affiliated department, and a project ID. Specifically, the data integration unit extracts data in parallel from a plurality of heterogeneous data sources using a distributed processing framework. The present system activates a dedicated application programming interface client corresponding to each data source as a container. The present system receives a multimodal data stream including structured data and unstructured data as input data. The input data includes tabular data from a relational database and time-series waveform data from a sensor. The present system executes synchronization of timestamps and unification of character codes as preprocessing. As a specific example of the input data, the present system processes a stamping event log per second acquired from the attendance management system. As another specific example, the present system processes a floating-point array of temperature and a carbon dioxide concentration in a one-minute cycle acquired from the office environment sensor. The present system deploys the extracted data on an in-memory data grid. The present system maps an employee identifier to a common internal identifier using a hash function. The present system generates a normalized integrated data object as output data. The output value means a state in which all history data related to a single employee are linked in a graph structure. As a specific example of the output, the present system outputs employee relationship graph data composed of nodes and edges. As another specific example, the present system outputs a multi-dimensional feature matrix sorted in time series. The present system persists the integrated data object to a distributed storage system as subsequent processing. With this configuration, the present system eliminates a data silo. The present system exhibits a technical effect of integrating a huge amount of petabyte-class data at high speed without omission, and minimizing a memory access delay in subsequent artificial intelligence processing. The present technology is applicable to use cases such as a resident behavior analysis platform in a smart city and an integrated monitoring system in a large-scale factory.

Preprocessing such as missing value imputation, outlier removal, quantification, category conversion, natural language processing, and smoothing and trend extraction of time-series data is automatically executed on the integrated data. For example, an unentered questionnaire item is imputed with an average value or a median value, and an extreme number of logins or unnatural overtime hours is excluded as an abnormal value. For unstructured data such as a free description of a questionnaire, an interview record, and SNS post content, emotion analysis and stress index extraction are performed by natural language processing by generative AI, and they are quantified and reflected in the integrated data as a feature. As a specific example of a prompt sentence to be read by the generative AI, “Based on content of a free description column of the following employee questionnaire, quantify a positive/negative emotion score from 0 to 1, and extract a sign of stress and engagement. Input: ‘I do not feel rewarded in my recent work. My relationship with my boss is becoming weak.’” and the like can be cited. Specifically, the data integration unit automatically executes a data cleansing pipeline. The present system loads an unprocessed integrated data matrix onto a memory as input data. The matrix is an incomplete tensor including a missing value and an outlier. The present system applies a statistical imputation algorithm and a machine learning-based anomaly detection algorithm as preprocessing. As a specific example of the input data, the present system processes a vector including a null value indicating an unanswered item of a questionnaire. As another specific example, the present system processes text data of an interview record described in a natural language. The present system executes natural language processing using a large language model on the text data. The model generates a word embedding vector and analyzes a context. The present system generates a cleansed complete feature tensor and an emotion score vector extracted from the text as output data. The output value means a numerical representation that can be directly calculated by a subsequent prediction model. As a specific example of the output, the present system outputs a numerical pair of a positive emotion score of 0.8 and a negative emotion score of 0.1. As another specific example, the present system outputs a flag variable 1 indicating a stress sign. The present system transfers the feature tensor to an input buffer of an artificial intelligence analysis unit as subsequent processing. With this configuration, the present system prevents a decrease in prediction accuracy due to noise or omission. The present system exhibits a technical effect of converting unstructured data into a quantitative feature in a high-dimensional vector space, and dramatically improving calculation efficiency by a computer. The present technology is applicable to use cases such as an automatic analysis system for an electronic medical record in a medical field and a customer voice analysis system in a financial field.

With the preprocessed integrated data as an input, a turnover risk score and an engagement score for each employee are calculated by a machine learning model utilizing generative AI. For example, a classification model using data of past retirees as teacher data and a regression model using an engagement survey result as teacher data are automatically generated and optimized by the generative AI, and a “probability of leaving the company within the next half year” and a “current engagement level” for each employee are output as a score from 0 to 1. The generative AI is also utilized for feature selection of the model, hyperparameter optimization, ensemble learning, automatic selection of an anomaly detection algorithm, and the like. As a specific example of a prompt sentence to be read by the generative AI, “Based on the following employee integrated data, calculate a turnover risk score and an engagement score from 0 to 1, and extract three major risk factors. Input: ‘increase in overtime hours, decrease in SNS remarks, non-consultation of health checkup, reduction in project role’” and the like can be cited. Specifically, the artificial intelligence analysis unit constructs an ensemble learning model combining a gradient boosting decision tree and a deep neural network. The present system transfers a preprocessed multi-dimensional feature tensor to a video memory of a graphics processing unit as input data. The tensor is a 512-dimensional numerical vector group indicating a past behavior history and a current state of each employee. The present system applies batch normalization to stabilize a distribution of input values as preprocessing. As a specific example of the input data, the present system processes a floating-point number indicating a moving average value of overtime hours. As another specific example, the present system processes a one-hot encoding vector of a categorical variable indicating a reduction in a project role. The model executes a non-linear transformation in a hidden layer and an operation using an activation function in parallel. The present system generates a predicted value of a turnover risk score and an engagement score as output data. The output value means a statistical probability that a target employee transitions to a specific state. As a specific example of the output, the present system outputs a numerical value of a turnover risk score of 0.75 and an engagement score of 0.45. As another specific example, the present system outputs an upper limit value of 0.80 and a lower limit value of 0.70 indicating a confidence interval of a prediction. The present system compares the score with a predetermined warning threshold as subsequent processing. When the score exceeds the threshold, the present system triggers an alert generation module. With this configuration, the present system realizes highly accurate risk prediction that does not depend on human intuition. The present system exhibits a technical effect of learning a complex non-linear relationship and maintaining generalization performance even for unknown data. The present technology is applicable to use cases such as a fraudulent use detection system for a credit card and a predictive maintenance system for equipment in a manufacturing industry.

The generative AI analyzes factors contributing to each score by explainable AI technology, and extracts factors of a risk and low engagement, such as a rapid increase in overtime hours, a reduction in a project role, a decrease in an SNS remark frequency, a decrease in welfare program usage, a decrease in an online meeting participation frequency, and non-consultation of a health checkup, in order of importance. For example, factors such as “for an employee B, overtime hours have increased 1.5 times in the latest two months, remarks on an internal SNS have halved, non-consultation of a health checkup, and chat remarks during telework have drastically decreased” are identified. As a specific example of a prompt sentence to be read by the generative AI, “Based on the following integrated data and score of an employee, extract three main factors of a turnover risk and an engagement decrease, and explain them in order of importance. Input: ‘increase in overtime hours, decrease in SNS remarks, non-consultation of health checkup, reduction in project role’” and the like can be cited. Specifically, the artificial intelligence analysis unit drives a factor analysis module implementing a Shapley additive explanations algorithm. The present system acquires an internal parameter of a prediction model and a feature vector of a target employee as input data. The present system generates perturbation data in a feature space and measures an output fluctuation of the model as preprocessing. As a specific example of the input data, the present system processes a feature value indicating an increase in overtime hours. As another specific example, the present system processes a binary feature indicating non-consultation of a health checkup. The analysis module calculates a marginal contribution degree given to a final prediction score by each feature. The present system generates structured data including an importance score for each feature and an explanatory text in a natural language by generative artificial intelligence as output data. The output value means presenting a judgment basis of black-boxed artificial intelligence in a format understandable by a human. As a specific example of the output, the present system outputs a numerical value of a contribution degree of overtime hours of plus 0.3 and a contribution degree of an SNS remark decrease of plus 0.15. As another specific example, the present system outputs text data that a rapid increase in overtime hours increases a turnover risk the most. The present system inputs the factor data to a prompt generation module of a measure proposal unit as subsequent processing. With this configuration, the present system ensures transparency and accountability for an inference result of artificial intelligence. The present system exhibits a technical effect of providing a logical foundation for deriving a specific improvement action, not limited to mere presentation of a score. The present technology is applicable to use cases such as a visualization system of a judgment basis in an autonomous driving vehicle and a presentation function of a diagnosis reason in a medical diagnosis support system.

Based on the output result of the AI analysis unit, the generative AI automatically proposes an optimal follow-up measure and organization improvement measure for individual employees and the entire organization. For example, for an employee with a high turnover risk and a low engagement, “implementation of an individual interview by an immediate supervisor”, “career path redesign”, “workload adjustment”, “guidance on mental health support”, “welfare program usage promotion”, “recommendation to participate in an internal event”, “mentoring introduction”, and the like are proposed, and for an employee with a high engagement but a high turnover risk, “review of a compensation and evaluation system”, “assignment to a new project”, “recommendation for an internal award”, “taking a skill-up training”, and the like are recommended. For the entire organization, issues such as “high-risk employees are concentrated in a specific department”, “there is a department where engagement tends to decrease”, “there is a group with a low welfare program usage rate”, and “a stress score increases in a remote work department” are extracted, and measures such as “company-wide work style reform”, “communication activation event”, “expansion of a welfare program system”, “enhancement of a remote work support measure”, and “promotion of a cross-departmental project” are proposed to the management team and the human resources department. As a specific example of a prompt sentence to be read by the generative AI, “Propose three optimal follow-up measures based on the following turnover risk score and engagement score of an employee, and major risk factors. Input: ‘turnover risk 0.85, engagement 0.32, factors: increase in overtime, decrease in SNS remarks, unconsulted health checkup’” and the like can be cited. Specifically, the measure proposal unit executes an inference pipeline utilizing a large language model. The system constructs a context vector including the turnover risk score, the engagement score, and a list of the extracted major risk factors as input data. The system embeds the context vector into a natural language prompt template as preprocessing. The system processes character string data including the turnover risk of 0.85 and the increase in overtime as a factor as a specific example of the input data. The system processes character string data including the engagement of 0.32 and the unconsulted health checkup as a factor as another specific example. The large language model autoregressively generates a token sequence of an optimal measure using a transformer network having billions of parameters. The system generates texts of a plurality of measure candidates and an expected effect score of each measure as output data. The output value means a priority of an intervention action most suitable for a profile of a target employee. The system outputs a text of implementation of an individual interview by an immediate supervisor and an expected effect score of 0.9 as a specific example of the output. The system outputs a text of workload adjustment and an expected effect score of 0.85 as another specific example. The system stores the measure candidates in a database and transmits a push notification to the user interface unit as subsequent processing. With this configuration, the system instantaneously searches for an optimal solution from a huge combination of measures. The system exhibits a technical effect of significantly reducing a cognitive load on a human resources person in charge and speeding up a decision-making process. This technology is applicable to use cases such as an automatic generation system for a personalized marketing campaign and an optimal answer proposal system in customer support.

Via the user interface unit, an analysis result and a measure proposal transmitted from the server can be browsed and operated on a dashboard, a notification screen, a report screen, and the like for users such as the management team, the human resources person in charge, the site manager, and the employee himself/herself. The user inputs feedback on measure implementation, a questionnaire answer, self-reported content, a reaction to the measure proposal, and the like from the terminal, and transmits them to the server. Thereby, an implementation status of the measure and effect data are collected in real time, and reflected in the AI analysis and the measure proposal from the next time onward. Specifically, the user interface unit establishes an always-connected bidirectional communication channel with the server using WebSocket communication. The system receives an analysis result payload in a JSON format push-distributed from the server as input data. The system stores the received data in a state management library on a client side and triggers redrawing of a screen component as preprocessing. The system processes array data including a measure proposal list for a specific employee as a specific example of the input data. The system processes coordinate data for drawing an engagement heat map of the entire organization as another specific example. The terminal detects a touch operation and a keyboard input from the user. The system generates an action log in which an operation event of the user is serialized as output data, and transmits the action log to the server. The output value means an acceptance state of the measure and a status of implementation completion. The system outputs log data with a time stamp indicating a click event of a measure implementation button as a specific example of the output. The system outputs text data including answer content of the questionnaire as another specific example. As subsequent processing, the data integration unit on the server side receives the action log, and asynchronously updates a corresponding record in the database. With this configuration, the system eliminates information delay and enables real-time situation grasping. The system exhibits a technical effect of streamlining data synchronization between a group of distributed terminals and a central server, and optimizing consumption of a network bandwidth. This technology is applicable to use cases such as a real-time monitoring dashboard for financial transactions and a dynamic tracking system for a logistics network.

The learning and optimization unit continuously learns a performance change after implementation of the measure (for example, a decrease in turnover risk, an improvement in engagement, an improvement in work productivity, an improvement in project progress, an increase in communication amount, and the like), and optimizes content and timing of the measure proposal. For example, when the turnover risk significantly decreases in a group of employees for whom “individual interview+workload adjustment” has been implemented in the past, the same measure is preferentially proposed to an employee having a similar tendency. Conversely, when a specific measure does not show an effect, the generative AI analyzes the reason and automatically selects another measure. As a specific example of a prompt sentence to be read by the generative AI, “When a ratio of employees whose turnover risk has decreased is high among employees for whom measure A has been implemented in the past six months, preferentially propose measure A to an employee having a similar profile” and the like can be cited. Specifically, the learning and optimization unit deploys a deep reinforcement learning agent based on a Markov decision process on the server. The system acquires a state tensor before implementation of the measure, an action vector of the selected measure, and a delayed reward scalar indicating a state change after implementation of the measure as input data. The system accumulates a past transition history in a replay buffer and randomly samples a mini-batch as preprocessing. The system processes a positive reward value indicating that the turnover risk has decreased by 0.3 after implementation of the individual interview as a specific example of the input data. The system processes a negative reward value indicating that productivity has decreased after the workload adjustment as another specific example. The agent updates a value function for a pair of a state and an action using a Q-learning algorithm. The system generates a weight parameter of an optimized policy network and a selection probability distribution of each measure as output data. The output value means an optimal action strategy acquired by the system through experience. The system outputs an update command to raise a selection probability of measure A for a similar profile to 0.8 as a specific example of the output. The system outputs an update command to lower a selection probability of measure B having a low effect to 0.1 as another specific example. The system deploys the updated policy network to an inference engine of the measure proposal unit as subsequent processing. With this configuration, the system autonomously adapts to a dynamic change in an environment without being bound by a static rule. The system exhibits a technical effect of continuously improving accuracy of the measure through trial and error and realizing long-term optimization. This technology is applicable to use cases such as an autonomous control system for a robot and a power distribution optimization system in a smart grid.

As described above, the system of the present invention comprehensively integrates multidimensional data of employees, analyzes a turnover risk and an engagement level with high accuracy by utilizing generative AI, automatically proposes an individually optimal measure, and continuously learns and optimizes a measure effect, thereby realizing performance maximization of the entire organization and prevention of human resource outflow. Specifically, the system integrally manages a plurality of independent container groups based on a microservice architecture on an orchestration platform. The system receives tens of thousands of event streams per second generated from all endpoints in the organization by a message queuing system as input data. The system executes data filtering and aggregation in real time using a stream processing engine as preprocessing. The system processes high-frequency data such as a login history of an employee and a transmission log of a chat as a specific example of the input data. The system processes low-frequency data such as a personnel evaluation score updated monthly as another specific example. The system executes inference processing using an artificial intelligence model in parallel on a cluster of graphics processing units. The system generates comprehensive dashboard data indicating soundness of the entire organization and an individual alert notification as output data. The output value means a quantitative index and a specific action plan for maximizing the performance of the organization. The system outputs time-series graph data indicating an average value of the company-wide turnover risk as a specific example of the output. The system outputs an urgent intervention instruction text to a manager of a specific department as another specific example. The system distributes the output data to each terminal and simultaneously archives the output data in a secure storage as an audit log as subsequent processing. With this configuration, the system automates data processing on a scale exceeding human cognitive limits. The system exhibits a technical effect of eliminating personalized judgment and providing a data-driven and self-evolving organization management infrastructure. This technology is applicable to use cases such as an integrated management system for a large-scale supply chain and a national-scale public health monitoring platform.

### Application Example 1

The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment for carrying out the present invention, a system configuration and a processing flow in a factory robot field will be described extremely specifically and comprehensively. The system of the present invention is composed of a server and a terminal, and includes a data integration unit, an AI analysis unit, a measure proposal unit, and a learning and optimization unit on a server side, and a user interface unit on a terminal side. The server cooperates with various databases inside and outside a factory, a site system, a sensor network, and an external information service, and bears high-load processing such as collection, integration, analysis, measure generation, and learning optimization of a huge amount of data. The terminal provides an interface for various users such as a site manager, an operation person in charge, and a worker to operate and browse a dashboard, a notification screen, a report screen, and the like, and performs bidirectional communication with the server. Specifically, the system adopts a hybrid architecture integrating edge computing and cloud computing. The system acquires raw data from a programmable logic controller and various sensor groups arranged in the factory via an industrial Ethernet protocol as input data. The system executes sampling rate conversion and noise filtering of data on an edge gateway as preprocessing. The system processes a current value in milliseconds and a pulse signal of an encoder acquired from a joint motor of a robot arm as a specific example of the input data. The system processes time-series data of temperature and humidity acquired from an environment sensor in the factory as another specific example. The server stores the received data in a distributed time-series database. The system generates user interface drawing data optimized for a screen resolution and an authority level of each terminal as output data. The output value means a structured view object for visualizing a site situation in real time. The system outputs factory-wide operation rate heat map data for the site manager as a specific example of the output. The system outputs alert detailed information and three-dimensional model data of corresponding equipment for the operation person in charge as another specific example. The system push-distributes the drawing data to each terminal via secure WebSocket communication as subsequent processing. With this configuration, the system efficiently processes traffic generated from a huge number of Internet of Things devices in the factory. The system exhibits a technical effect of minimizing a network delay and supporting real-time decision-making in a mission-critical site operation. This technology is applicable to use cases such as a fleet management system for an autonomous vehicle and a wide-area field monitoring system in smart agriculture.

The data integration unit operates on the server, and automatically and periodically collects and integrates a wide variety of data relating to robots, equipment, workers, a site environment, and a supply chain in the factory. For example, from the robots and the equipment, operation logs (operation time, the number of stops, an error occurrence history, an operation mode history, power consumption, and sensor values such as temperature, vibration, and current), maintenance histories (the latest inspection date, a replaced part, repair content, a maintenance person in charge, a state record at the time of inspection, a part replacement cycle, and a maintenance cost), abnormality detection logs (sensor abnormality, temperature abnormality, vibration abnormality, an alarm occurrence history, an abnormality score by an AI abnormality detection algorithm, an abnormality occurrence time, and an operation condition at the time of abnormality occurrence), work instruction histories (which robot was in charge of which work and when, a required time until work completion, a work interruption history, a change history of a work procedure, a work priority, and an issuer of a work instruction), quality inspection data (an inspection result for each product, a defect rate, a robot ID and a work condition at the time of inspection, an inspector comment, a determination result of image inspection AI, and an environmental condition at the time of inspection), site environment sensor data (temperature, humidity, dust concentration, noise level, illuminance, CO2 concentration, seat utilization rate, in-office movement history, environmental fluctuation by area, air conditioning operation status, and the number of ventilations), health and safety data of workers (vital data of a worker, work time of a worker, a break acquisition status, a safety education attendance history, a fatigue score of a worker, a near-miss report of a worker, a health checkup result of a worker, and a stress check result of a worker), site communication histories (a contact frequency between workers, an exchange of a site chat, a transmission history of a work instruction, content of a trouble report, minutes of a site meeting, an improvement proposal from a worker, and feedback from a site leader), external supply chain information (a part delivery delay, a raw material inventory status, an operation status of an outsourcing destination, a logistics trouble, delivery date change information, quality evaluation of a supplier, a delivery record, and a supply risk due to an external factor), and the like are acquired by an API, batch processing, an IoT gateway, file linkage, or the like, and centrally stored in a database by linking the data with a common key such as a robot ID, an equipment ID, a worker ID, a work instruction ID, and a product lot number. Specifically, the data integration unit executes a plurality of data collection daemons implementing asynchronous input/output processing in parallel. The system receives stream data and batch data from a wide variety of sources having different communication protocols and data formats as input data. The system serializes all data into a JSON format which is a unified internal representation using a protocol conversion module as preprocessing. The system processes an operation status code transmitted from a control panel of the robot by an MQTT protocol as a specific example of the input data. The system processes a high-resolution image tensor transmitted from a quality inspection camera as another specific example. The system processes an integer value of the number of part inventories acquired from a supply chain management system via a RESTful API as still another specific example. The system stores these data in a hybrid cluster of a relational database and a NoSQL database using a common time stamp and a unique identifier. The system generates an integrated data set for which normalization and indexing have been completed as output data. The output value means that a multidimensional feature space directly readable by a subsequent machine learning model has been constructed. The system outputs a time-series matrix including all sensor values for the past 30 days associated with a specific robot ID as a specific example of the output. The system outputs graph structure data in which a worker ID and an operation history of equipment in charge are combined as another specific example. The system issues an update event of the integrated data set to a message broker and triggers processing of the artificial intelligence analysis unit as subsequent processing. With this configuration, the system integrates siloed data scattered inside and outside the factory as a single reliable information source. The system exhibits a technical effect of dramatically reducing a calculation cost required for data search and extraction. This technology is applicable to use cases such as a flight data recorder analysis system for an aircraft and an inventory optimization system for a large-scale logistics warehouse.

For example, for a robot A, a transition of operation time in the latest one week, an error occurrence frequency, the number of occurrences of abnormal vibration, a maintenance history, work content in charge, a site temperature and humidity during work, a cooperation history with a worker B, a quality inspection result of a product in charge, the latest part delivery status, a trouble report in a site chat, a wear degree of a consumable part, an image inspection result by AI, a detailed operation condition at the time of abnormality occurrence, and the like are all integrated in chronological order. For a worker C, work time, a break acquisition status, vital data, a near-miss report, a safety education attendance history, a site communication history, an operation status of a robot or equipment in charge, an environment sensor value during work, a stress check result, a health checkup result, a cooperation history between workers, an evaluation comment from a site leader, and the like are integrated. Specifically, the data integration unit uses an entity resolution algorithm to consolidate identifiers having a mismatch between different systems, and constructs a single profile object. The system expands a fragmentary record group extracted from each subsystem on a memory as input data. The system unifies a time zone of a time stamp to Coordinated Universal Time and fills a missing part of a time series by linear interpolation as preprocessing. The system processes a floating-point number indicating the operation time of the robot A and an integer value indicating the number of occurrences of abnormal vibration as a specific example of the input data. The system processes a time-series array of a heart rate indicating the vital data of the worker C and a score value of the stress check as another specific example. The system combines these heterogeneous data as a multidimensional array. The system generates a feature tensor expressing a complete state history of each entity as output data. The output value means an input infrastructure for the machine learning model to predict a future state from a past behavior of the entity. The system outputs a 1024-dimensional time-series feature vector relating to the robot A as a specific example of the output. The system outputs a 512-dimensional behavior and health state vector relating to the worker C as another specific example. The system stores the feature tensor in a distributed cache memory to enable high-speed reading as subsequent processing. With this configuration, the system models a site event intertwined complicatedly as a quantitative data structure. The system exhibits a technical effect of expressing a hidden correlation between multivariates that cannot be grasped by a human in a format computable by a computer. This technology is applicable to use cases such as an integrated electronic medical record system for a patient in a medical institution and an omnidirectional credit evaluation system for a customer in a financial institution.

After data acquisition, the data integration unit automatically executes preprocessing such as missing value imputation (for example, imputing an unrecorded sensor value with a peripheral value or a past value, and imputing uninput vital data of a worker with the latest health checkup value), outlier removal (for example, excluding a clearly abnormal temperature value or operation time, and a spike value due to sensor noise), quantification and category conversion (for example, converting work content or an abnormality type into a category value, scoring a health state of a worker, and quantifying a communication frequency), natural language processing (for example, extracting and quantifying a sign of stress or cooperation failure from a free description of a worker or site chat content, extracting a risk factor from a trouble report, and classifying content of an improvement proposal), smoothing and trend extraction of time-series data (for example, detecting a moving average or a rapid change point of operation time or an abnormality occurrence frequency, and a time-series transition of a fatigue score of a worker), AI analysis of image data (for example, extracting a defect detection score from a quality inspection image, and quantifying a wear degree from an image of a worn part), and AI analysis of voice data (for example, extracting an activity level of a discussion or a tension degree at the time of trouble occurrence from a recording of a site meeting). The generative AI is indispensable especially for analysis of a free description of a worker and a site chat, pattern extraction of an abnormality detection log, discovery of a complex correlation, and analysis of image and voice data, and performs analysis by giving a prompt such as “Extract a sign of a failure risk or a quality risk from an operation log and an abnormality detection log of a robot A for the past one week, and chat content of a worker”, “Extract a sign of cooperation failure or stress between workers from content of a site chat”, and “Extract a feature of a defective product from a quality inspection image, and analyze a correlation with an operation condition of a robot”. Specifically, the data integration unit sequentially executes a plurality of microservices constituting a data preprocessing pipeline. The system acquires a raw integrated data set including noise and a missing value as input data. The system executes smoothing of time-series data using a Kalman filter, and detection and exclusion of an outlier using an isolation forest algorithm as preprocessing. The system processes an array of temperature data including a null value caused by a communication error of a sensor as a specific example of the input data. The system processes text data of a trouble report in a natural language input by a worker as another specific example. The system applies a transformer-based large language model to the text data, and generates an embedding vector of a context. The system generates a high-dimensional feature matrix for which cleansing and quantification have been completed as output data. The output value means a clean data structure optimized for learning and inference of a subsequent prediction model. The system outputs a tensor of a continuous value in which a missing value is imputed with a peripheral average value as a specific example of the output. The system outputs a normalized score from 0 to 1 indicating a risk level extracted from the trouble report text as another specific example. The system transmits the feature matrix to an input queue of the artificial intelligence analysis unit as subsequent processing. With this configuration, the system automatically ensures quality of the input data and avoids a garbage-in garbage-out problem. The system exhibits a technical effect of quantitatively extracting a potential risk factor from unstructured data and dramatically improving accuracy of the prediction model. This technology is applicable to use cases such as a sentiment analysis system for analyzing a post on social media, and an automatic text conversion and emotion analysis system for a customer voice in a call center.

The AI analysis unit operates on the server, and calculates a “failure occurrence probability within the next one week”, a “quality defect occurrence risk”, and a “work efficiency reduction risk” of each robot and equipment as a score from 0 to 1 by a machine learning model utilizing generative AI with the integrated data as an input. The model automatically optimizes multidimensional features such as an operation pattern, an abnormality detection log, a site environment, a state of a worker, a supply chain status, a work instruction history, quality inspection data, and a communication history using a past failure/defect occurrence history as teacher data, and performs risk prediction. For example, when the operation time of the robot A rapidly increases, abnormal vibration frequently occurs, and the robot A continuously operates in a state where the site temperature is high, a failure risk score is calculated to be high. When a robot B exceeds a replacement cycle of a consumable part and an AI abnormality detection score increases, it is determined that necessity of preventive maintenance is high. When the worker C has a high fatigue score, insufficient break acquisition, and many trouble reports in the site chat, a work efficiency reduction risk of a robot or equipment in charge is calculated to be high. In the quality inspection data, when a defect rate is high in a product in charge of a specific robot, a correlation with an operation condition of the robot, a skill of a worker, and a site environment is automatically extracted. The generative AI is also utilized for feature selection of a model, hyperparameter optimization, ensemble learning, automatic selection of an abnormality detection algorithm, factor extraction by explainable AI technology, and the like. Specifically, the artificial intelligence analysis unit drives a multimodal deep learning model integrating a long short-term memory network and a convolutional neural network. The system loads a composite tensor including preprocessed time-series sensor data, an image feature vector, and a text embedding vector to a graphics processing unit as input data. The system applies a fully connected layer for projecting data of each modality into the same dimensional space as preprocessing. The system processes vibration sensor waveform data of the robot A for the past 7 days as a specific example of the input data. The system processes a vector including the fatigue score of the worker C and a negative emotion score of the site chat as another specific example. The model simultaneously learns a temporal dependency and a spatial feature pattern. The system generates a distribution of a prediction probability for each risk category as output data. The output value means a statistical likelihood that target equipment or a worker transitions to an abnormal state in the near future. The system outputs numerical values of a failure occurrence probability of 0.85 and a quality defect occurrence risk of 0.60 of the robot A as a specific example of the output. The system outputs a numerical value of a work efficiency reduction risk of 0.75 of the worker C as another specific example. The system compares the prediction probability with a dynamically set threshold value as subsequent processing, and immediately fires an alert event when a sign of abnormality is detected. With this configuration, the system surpasses a conventional abnormality detection method depending on a single sensor threshold value. The system exhibits a technical effect of analyzing a complex interaction of multivariate data and predicting a serious failure in advance from a minute change unnoticed by a human. This technology is applicable to use cases such as a predictive maintenance system for a turbine in a power plant and a crash prediction system for algorithmic trading in a financial market.

The AI analysis unit analyzes a factor contributing to each risk score by explainable AI technology, and extracts a risk factor such as “rapid increase in operation time”, “frequent occurrence of abnormal vibration”, “continuous operation under a high-temperature environment”, “part delivery delay”, “fatigue accumulation of a worker”, “trouble occurrence in a site chat”, “increase in defect rate in quality inspection”, “wear degree of a consumable part”, “frequent change of a work procedure”, and “delivery date delay of a supply chain” in order of importance. For example, for the robot B, “abnormal vibration occurred three times in the latest two days”, “no replacement history of a consumable part”, “site temperature exceeds 40 degrees”, “fatigue score of a worker D is high”, and the like are specified as a main cause of an increase in failure risk. For the worker C, “work time exceeds 10 continuous hours”, “break acquisition is less than once every two hours”, “frequent trouble reports in a site chat”, “multiple alerts in feedback from a site leader”, and the like are extracted as a main cause of a work efficiency reduction risk. A root cause of defective product occurrence is specified by combining a determination result of quality inspection AI, an operation condition of a robot, a skill of a worker, and a fluctuation of a site environment. Specifically, the artificial intelligence analysis unit executes an explainable artificial intelligence module using a gradient-based saliency map generation algorithm and a local surrogate model. The system acquires an inference result tensor of a deep learning model and gradient information of the model with respect to an input feature as input data. The system performs random sampling in the vicinity of an input space and constructs a linear model approximating a local decision boundary of the model as preprocessing. The system processes a failure risk score of 0.9 of the robot B and all feature vectors used for calculation thereof as a specific example of the input data. The system processes a work efficiency reduction risk of 0.8 of the worker C and related behavior history data as another specific example. The module quantitatively calculates an influence degree given by each feature to an increase or a decrease in a prediction score. The system generates a list in which a contribution score for each feature is sorted in descending order, and an explanation text in a natural language by generative artificial intelligence as output data. The output value means a result of converting an inference logic of a black box model into an interpretable format. The system outputs numerical values of a contribution of abnormal vibration of plus 0.4 and a contribution of a site temperature of plus 0.25 as a specific example of the output. The system outputs text data that work time exceeding 10 continuous hours is a main cause of a risk as another specific example. The system transfers the factor list as a context input of the measure proposal unit as subsequent processing. With this configuration, the system fosters reliability of a site person in charge for prediction of artificial intelligence. The system exhibits a technical effect of automating specification of a root cause and dramatically shortening a time required for troubleshooting, not limited to mere presentation of a warning. This technology is applicable to use cases such as a highlight display system for a lesion site in medical image diagnosis and a specification system for a malware infection route in cybersecurity.

The measure proposal unit operates on the server, and automatically proposes an optimal maintenance plan, work assignment, and site improvement measure for individual robots, equipment, workers, and the entire site based on an output result of the AI analysis unit. The generative AI also learns a past measure implementation history and effect data thereof, and automatically selects a measure estimated to have the highest effect for each robot or equipment. For example, for a robot A, since operation under abnormal vibration and a high-temperature environment continues, “immediate maintenance and operation stop” is recommended; for a robot B, since an operation time tends to increase and there is no parts replacement history, “implementation of preventive maintenance and adjustment of operation load” is recommended; and for a robot C, since a risk is particularly low, “normal operation and periodic inspection” is recommended. For a worker D, “review of work assignment and increase in break time due to a high fatigue score” is proposed; and for the entire site, site improvement measures such as “review of an operation schedule of an entire line due to concentration of high-risk robots on a specific line”, “review of a work procedure in a specific time zone due to an increase in a quality defect rate in the corresponding time zone”, “increase in a replacement frequency of workers”, “strengthening of air conditioning in the site environment”, “diversification of parts procurement sources against a delivery delay in the supply chain”, “early alert notification to a site leader”, and “risk sharing in a site meeting” are proposed. The generative AI is also utilized for automatic generation of a measure proposal text, effect prediction after measure implementation, prioritization of measures, customization of measures (for example, fine adjustment of proposal content according to a robot model, work content, and a worker's skill and health condition), automatic optimization of measures referring to past trouble trends and success cases at the site, and the like. Specifically, the measure proposal unit executes a retrieval-augmented generation pipeline combining a large language model and a knowledge graph. The system constructs a context vector including a risk score of a target entity, an extracted main risk factor, and a past maintenance history as input data. The system extracts a related past success case and standard operating procedure manual from the knowledge graph by vector search as preprocessing. The system processes character string data indicating the abnormal vibration and the operation under the high-temperature environment of the robot A as a specific example of the input data. The system processes character string data indicating the high fatigue score and the lack of break of the worker D as another specific example. The large language model integrates the extracted knowledge into a prompt, and generates a text of an optimal measure. The system generates a text of a specific action plan and a score indicating an expected risk reduction effect of each measure as output data. The output value means an intervention method most suitable for a site situation and a priority thereof. The system outputs a text of immediate maintenance and operation stop and an expected effect score of 0.95 as a specific example of the output. The system outputs a text of review of work assignment and increase in break time and an expected effect score of 0.88 as another specific example. The system stores the measure proposal data in a database and transmits a push notification to terminals of a related site manager and maintenance person in charge as subsequent processing. With this configuration, the system formalizes tacit knowledge of a skilled technician and shares the formalized knowledge in the entire system. The system instantly derives an optimal countermeasure according to a situation, and exhibits a technical effect of realizing minimization of downtime and maximization of productivity. The present technology is applicable to use cases such as a failure recovery automation system for IT infrastructure and an automatic generation system for an optimal evacuation route and relief supply delivery plan in the event of a disaster.

The learning and optimization unit operates on the server, continuously learns a performance change after measure implementation (for example, failure risk reduction, quality defect rate reduction, work efficiency improvement, downtime shortening, site trouble reduction, worker's health index improvement, etc.), and optimizes content and timing of a measure proposal. For example, when a failure risk is significantly reduced in a robot group in which “immediate maintenance upon abnormal vibration detection” has been implemented in the past, the same measure is preferentially proposed to a robot having a similar tendency. Conversely, when a specific measure does not show an effect, the generative AI analyzes a reason thereof, and automatically selects another measure. Implementation timing and a combination of measures (for example, “parts replacement+operation load adjustment”, “worker replacement+break increase”, “site environment improvement+work procedure review”, etc.) are also optimized. Various indexes such as real-time site data, feedback from workers, a quality inspection result, a downtime record, the number of trouble reports, and discussion content in a site meeting are used for measuring an effect of a measure. Specifically, the learning and optimization unit implements a deep reinforcement learning algorithm using an actor-critic method. The system acquires a state vector indicating a site state before measure implementation, an action vector indicating an executed measure, and a reward scalar indicating a change in a performance index after measure implementation as input data. The system normalizes a reward signal and applies a temporal discount rate to calculate a cumulative reward as preprocessing. The system processes a positive reward value indicating that the failure risk is reduced by 0.5 after implementation of the immediate maintenance upon abnormal vibration detection as a specific example of the input data. The system processes a zero or negative reward value indicating that the quality defect rate is not improved after specific parts replacement as another specific example. The system evaluates a state value using a critic network, and updates an optimal policy using an actor network. The system generates an updated weight parameter of a neural network and a selection probability distribution of each measure as output data. The output value means the latest optimization strategy acquired by the system through feedback from the site. The system outputs an update command to raise a selection probability of the immediate maintenance for a similar abnormal vibration pattern to 0.9 as a specific example of the output. The system outputs an update command to lower a selection probability of a measure having a low effect as another specific example. The system synchronizes the updated model parameter to an inference engine of the measure proposal unit as subsequent processing. With this configuration, the system breaks through a limit of a static rule base, and autonomously adapts to an environmental change of a factory and aging degradation of equipment. The system exhibits a technical effect of progressively improving a success probability of a measure by running a continuous learning loop. The present technology is applicable to use cases such as an air conditioning energy optimization system for a data center and a dynamic control system for a traffic signal network.

The user interface unit operates on the terminal, and enables a user such as a site manager, a maintenance person in charge, and a worker to browse and operate an analysis result and a measure proposal transmitted from the server on a dashboard, a notification screen, a report screen, and the like. For example, the site manager uses a dashboard capable of overlooking a risk distribution of the entire factory, a trend by line, and a transition of a measure implementation history and an effect, the maintenance person in charge uses a screen capable of confirming details of a risk factor and a measure proposal of an individual robot or equipment, a past response history, and a measure effect, and the worker uses a screen capable of browsing and inputting his/her own work assignment and health condition, a recommended break/safety measure, and a report/feedback of a site trouble. Operation content from the terminal (for example, feedback of measure implementation, a site trouble report, a reaction to a measure proposal, and an improvement proposal from a worker) is transmitted to the server, and is reflected in AI analysis and a measure proposal from the next time onward in real time. Specifically, the user interface unit adopts a single-page application architecture, and realizes high-speed rendering on a client side. The system receives real-time update data in a JSON format streaming-distributed from the server via a WebSocket as input data. The system maps the received data to a virtual DOM tree and reflects only a difference on an actual screen as preprocessing. The system processes coordinate data and a color scale value indicating the risk distribution of the entire factory as a specific example of the input data. The system processes array data of a measure proposal text and a past response history of an individual robot as another specific example. The terminal detects a touch panel operation and a voice input from the user. The system generates an event payload encapsulating the operation content of the user as output data, and asynchronously transmits the event payload to an API endpoint of the server. The output value means a trigger for transmitting feedback from the site and occurrence of a new event to the entire system. The system outputs a status update log with a time stamp indicating pressing of a measure implementation completion button as a specific example of the output. The system outputs text data of a site trouble report input by the worker as another specific example. The system causes the data integration unit on the server side to receive the event payload, immediately update a database, and start a next analysis cycle as subsequent processing. With this configuration, the system resolves information asymmetry between the site and the server. The system achieves both intuitive operability and responsiveness in milliseconds, and exhibits a technical effect of significantly improving work efficiency of a site worker. The present technology is applicable to use cases such as a radar monitoring console for an air traffic controller and a patient monitoring terminal in a medical site.

In addition, from a viewpoint of security and privacy protection, data encryption, access authority management, anonymization processing, audit log recording, and the like are also strictly executed on the server side. For example, personal information and confidential information are encrypted and stored, and only minimum necessary information is decrypted and displayed at the time of analysis and visualization. Access authority is finely set according to a role of a user, and the site manager can browse the entire data, but the maintenance person in charge can browse only data of equipment in charge, and the worker can browse only his/her own data. Specifically, the system executes data protection using an advanced encryption algorithm. The server performs block encryption processing on input raw data using a 256-bit encryption key. The processing unit stores the encrypted data in a distributed storage. When receiving an access request, the system refers to a dynamic access control list. The control unit analyzes an authentication token of a user. The system collates an authority level included in the token with a security tag of a requested data resource. By this collation processing, the system physically and logically blocks unauthorized access. In the anonymization processing, the system irreversibly converts attribute data capable of identifying an individual by a hash function. This conversion processing protects privacy while maintaining statistical usefulness of data. The system includes an audit log recording unit. The recording unit records all data access events together with time stamps in an append-only database. The database has an anti-tampering function. The system executes these security processings in a hardware security module. By this hardware processing, the system minimizes calculation overhead of encryption and decryption processing. The system prevents a decrease in processing speed. The system automatically masks confidential information from text data before input to a large language model. This masking processing uses a named entity recognition model. The model detects a person's name and an identification number in a text, and replaces them with a dummy token. By this replacement processing, the system prevents confidential information from leaking to an external inference cluster. After receiving an inference result, the system reversely replaces the dummy token with original information. This reverse replacement processing is executed in a secure memory area. The system reduces a data leakage risk by these processings. The system is particularly effective in a use case requiring high confidentiality such as a medical equipment manufacturing factory and an aerospace parts factory. The system brings about a technical effect of achieving both security and data utilization.

As described above, the embodiment of the present invention realizes the data integration unit, the AI analysis unit, the measure proposal unit, and the learning and optimization unit on the server, and realizes the user interface unit on the terminal, thereby comprehensively and safely integrating a wide variety of data relating to robots, equipment, workers, a site environment, and a supply chain in a factory, realizing advanced risk analysis using generative AI, automatic proposal of an optimal measure, and continuous learning and optimization of a measure effect, and enabling innovative efficiency improvement and optimization of entire factory operation, such as real-time and individually optimal information provision to all of a site manager, a maintenance person in charge, and a worker, maximization of site performance, minimization of downtime, quality stabilization, safety improvement, reduction of a worker's burden, and strengthening of supply chain cooperation. Specifically, the system takes a cluster configuration in which a plurality of independent arithmetic modules are connected by a high-speed internal bus. The system normalizes stream data of heterogeneous formats in real time in the data integration unit. The system expands the normalized data as a multidimensional tensor on a memory. The system executes ensemble learning combining a large language model and a time-series prediction model in the AI analysis unit. The system calculates an optimal action value function using a reinforcement learning algorithm in the measure proposal unit. The system dynamically updates a weight parameter of each model using a backpropagation method in the learning and optimization unit. The system speeds up these processings using a parallel arithmetic core of a graphics processing unit. The system models a complex non-linear relationship that cannot be handled by a conventional rule-based system. The system calculates an interaction of feature amounts in a high-dimensional space. The system directly adjusts a control parameter of a physical device in the factory based on a calculation result. The system significantly improves prediction accuracy of downtime compared to a conventional method. The system optimizes data synchronization between an edge device and a cloud server while suppressing consumption of a communication band. The system adopts a protocol for compressing and transmitting only difference data. The system is applied to a large-scale and complex production line such as an automobile manufacturing factory and a semiconductor manufacturing factory. The system provides a clear technical effect of improving production efficiency and reducing an operation cost. The system realizes data-driven autonomous factory operation that does not depend on human intuition or experience.

### System Configuration

The system according to the present embodiment includes a data integration unit, an AI analysis unit, a measure proposal unit, a learning and optimization unit, and a user interface unit. The data integration unit has a function of automatically and periodically collecting and integrating a wide variety of data relating to robots, equipment, workers, a site environment, and a supply chain in a factory. For example, from a robot and equipment, an operation time, the number of stops, an error occurrence history, an operation mode history, power consumption, and a sensor value such as temperature, vibration, and current are acquired as an operation log, and the latest inspection date, a replacement part, repair content, a person in charge of maintenance, a state record at the time of inspection, a parts replacement cycle, and a maintenance cost are acquired as a maintenance history. As an abnormality detection log, a sensor abnormality, a temperature abnormality, a vibration abnormality, an alarm occurrence history, an abnormality score by an AI abnormality detection algorithm, an abnormality occurrence time, and an operation condition at the time of abnormality occurrence are acquired, and as a work instruction history, which robot was in charge of which work and when, a required time until work completion, a work interruption history, a change history of a work procedure, a work priority, and an issuer of a work instruction are acquired. As quality inspection data, an inspection result for each product, a defect rate, a robot ID and a work condition at the time of inspection, an inspector comment, a determination result of image inspection AI, and an environmental condition at the time of inspection are acquired, and as site environment sensor data, temperature, humidity, dust concentration, a noise level, illuminance, CO2 concentration, a seat utilization rate, an in-office movement history, an environmental change by area, an air conditioning operation status, and the number of times of ventilation are acquired. As health and safety data of a worker, vital data of a worker, a work time of a worker, a break acquisition status, a safety education attendance history, a fatigue score of a worker, a near-miss report of a worker, a health checkup result of a worker, and a stress check result of a worker are acquired, and as a site communication history, a contact frequency between workers, an exchange of a site chat, a transmission history of a work instruction, content of a trouble report, minutes of a site meeting, an improvement proposal from a worker, and feedback from a site leader are acquired. As external supply chain information, a parts delivery delay, a raw material inventory status, an operation status of an outsourcing destination, a logistics trouble, delivery date change information, quality evaluation of a supplier, a delivery record, and a supply risk due to an external factor are acquired. These data are centrally stored in a database by linking the data with a common key such as a robot ID, an equipment ID, a worker ID, a work instruction ID, and a product lot number, and preprocessing such as missing value imputation, outlier removal, quantification, category conversion, natural language processing, smoothing and trend extraction of time-series data, AI analysis of image data, and AI analysis of voice data is automatically executed. Specific examples of a prompt text to be read by generative AI include “Extract a sign of a failure risk and a quality risk from an operation log and an abnormality detection log of a robot A for the past week, and chat content of a worker”, “Extract a sign of cooperation failure and stress between workers from content of a site chat”, and “Extract a feature of a defective product from a quality inspection image, and analyze a correlation with an operation condition of a robot”. Specifically, the data integration unit asynchronously receives stream data using a distributed messaging queue. The system synchronizes the received data on a time stamp basis. The system converts data from heterogeneous data sources into a common multidimensional tensor format. The system simultaneously processes, for example, a one-dimensional time-series array from a temperature sensor, a three-dimensional image tensor from an image inspection camera, and a natural language text from a chat log. The system inputs the natural language text to an embedding layer of a large language model. The system converts the text into a 768-dimensional dense vector. The system inputs the image tensor to a convolutional neural network. The system extracts a 256-dimensional feature vector from the image. The system inputs the time-series array to a long short-term memory network. The system generates a time-series hidden state vector. The system combines these vectors of different modalities in a combining layer. The system holds the combined vector as an integrated feature amount tensor on a memory. In the missing value imputation, the system executes a reconstruction algorithm using an autoencoder. In the outlier removal, the system calculates an outlier score using an isolation forest algorithm. The system automatically filters a data point whose outlier score exceeds a predetermined threshold. The system distributedly executes these preprocessings on an edge computing device. The system reduces a data transfer amount to the server. The system minimizes consumption of a network band. The system transfers the preprocessed integrated feature amount tensor to the subsequent AI analysis unit. The system is applied to an environment where various sensors are mixed, such as a food processing factory and a chemical plant. The system brings about a technical effect of eliminating data silos and enabling integrated data analysis. The system significantly shortens a calculation time required for data preprocessing compared to a conventional method.

The AI analysis unit has a function of calculating a failure occurrence probability, a quality defect occurrence risk, and a work efficiency reduction risk within the next one week of each robot and equipment as a score from 0 to 1 by a machine learning model utilizing generative AI with the integrated data as an input. For example, using a past failure/defect occurrence history as teacher data, multidimensional feature amounts such as an operation pattern, an abnormality detection log, a site environment, a worker's state, a supply chain situation, a work instruction history, quality inspection data, and a communication history are automatically optimized to perform risk prediction. When an operation time of a robot A rapidly increases, abnormal vibration frequently occurs, and continuous operation is performed in a state where a site temperature is high, a failure risk score is calculated to be high. When a robot B exceeds a replacement cycle of consumable parts and an AI abnormality detection score is rising, it is determined that necessity of preventive maintenance is high. When a worker C has a high fatigue score, lack of break acquisition, and many trouble reports in a site chat, a work efficiency reduction risk of a robot or equipment in charge is calculated to be high. In quality inspection data, when a defect rate is high in a product handled by a specific robot, a correlation with an operation condition of the robot, a worker's skill, and a site environment is automatically extracted. The AI analysis unit also utilizes the generative AI for feature amount selection of a model, hyperparameter optimization, ensemble learning, automatic selection of an abnormality detection algorithm, factor extraction by explainable AI technology, and the like. Specific examples of a prompt text to be read by the generative AI include “Extract a failure risk score and three main risk factors of a robot B from the following integrated data. Input: operation time increase, frequent abnormal vibration, unreplaced consumable parts, site temperature rise”. Specifically, the AI analysis unit implements a deep learning model based on a transformer architecture. The system supplies the preprocessed integrated feature amount tensor to an input layer of the model. The input tensor has, for example, a three-dimensional structure of a batch size, a sequence length, and a feature amount dimension. The system calculates a hidden correlation between different feature amounts using a self-attention mechanism. The system quantifies, for example, a non-linear interaction between a specific frequency component of vibration data of a robot and a time-series pattern of a temperature change at a site. The system outputs a prediction score from a final output layer through a multilayer perceptron layer. The system generates a continuous value score from 0.0 to 1.0 indicating a failure occurrence probability, a probability distribution vector indicating a quality defect occurrence risk, and a categorical label indicating a work efficiency reduction risk as output data. The system outputs, for example, 0.87 as a failure risk score of the robot A. At the same time, the system specifies top three feature amounts contributing to the score by a gradient-weighted class activation mapping method. The system outputs a contribution degree of the specified feature amount as a numerical vector. The system writes these output results in a memory buffer as an input of the subsequent measure proposal unit. The system uses a cross-entropy error function and an Adam optimization algorithm in learning of the model. The system iteratively updates a weight parameter of the model using a pair of a huge amount of past operation logs and a failure label. The system applies dropout processing and batch normalization processing to each layer in order to prevent overlearning. The system converts a numerical prediction result into a natural language report using a large language model. The system generates, for example, a text “In a third joint motor of a robot A, a probability that bearing seizure occurs within 72 hours due to a composite factor of high-frequency vibration and temperature rise is 87 percent” from the input numerical vector. The system is applied to a use case requiring strict quality control such as a precision machine manufacturing factory and a pharmaceutical factory. The system brings about a technical effect of early detecting a sign of a minute abnormality that is difficult for a human expert to discover. The system prevents an economic loss due to a sudden equipment stop.

The measure proposal unit has a function of automatically proposing an optimal maintenance plan, work assignment, and site improvement measure for individual robots, equipment, workers, and the entire site based on the output result of the AI analysis unit. For example, for a robot A, since operation under abnormal vibration and a high-temperature environment continues, immediate maintenance and operation stop are recommended; for a robot B, since an operation time tends to increase and there is no parts replacement history, implementation of preventive maintenance and adjustment of operation load are recommended; and for a robot C, since a risk is particularly low, normal operation and periodic inspection are recommended. For a worker D, review of work assignment and increase in break time are proposed due to a high fatigue score; and for the entire site, site improvement measures such as review of an operation schedule of an entire line due to concentration of high-risk robots on a specific line, review of a work procedure in a specific time zone due to an increase in a quality defect rate in the corresponding time zone, increase in a replacement frequency of workers, strengthening of air conditioning in the site environment, diversification of parts procurement sources against a delivery delay in the supply chain, early alert notification to a site leader, and risk sharing in a site meeting are proposed. The generative AI is also utilized for automatic generation of a measure proposal text, effect prediction after measure implementation, prioritization of measures, customization of measures, automatic optimization of measures referring to past trouble trends and success cases at the site, and the like. Specific examples of a prompt text to be read by the generative AI include “Failure risk score of robot A: 0.85, main factors: frequent abnormal vibration, site temperature rise, unreplaced consumable parts. Generate three optimal maintenance proposals”. Specifically, the measure proposal unit includes a reinforcement learning-based decision-making engine. The system receives a risk score vector and a factor contribution degree vector output from the AI analysis unit as a state space. The system defines a combination of possible measures as an action space. The system calculates an optimal policy that maximizes a future cumulative reward using a Markov decision process model. The system sets a multi-objective function combining improvement of an operation rate of equipment, minimization of a maintenance cost, and maximization of a product yield as a reward function. The system iteratively updates a value of each action in each state using a Q-learning algorithm. The system generates a specific control command and schedule change instruction based on the calculated optimal policy. The system generates, for example, an immediate stop command for the robot A, and directly transmits the command to a programmable logic controller. At the same time, the system transmits an automatic ordering request for maintenance parts to an enterprise resource planning system. The system generates a natural language text explaining a basis of the calculated measure using a large language model. The system uses a set of a state vector, an action vector, and an expected reward value as an input. The system generates structured proposal data in a JSON format and a human-readable text report as an output. The system outputs, for example, structured data “Measure ID: 1024, Target: Robot A, Action: Replacement of spindle motor, Expected effect: 48-hour reduction of downtime, Priority: Highest”. The system pushes the generated proposal data to a display queue of the user interface unit. When a plurality of measures conflict, the system resolves resource conflict using a constraint satisfaction problem solver. The system inputs, for example, a shift schedule of maintenance personnel and an inventory status of parts as constraint conditions, and outputs an executable optimal schedule. The system is applied to a use case where a complex resource constraint exists, such as a steel plant and a large-scale logistics center. The system brings about a technical effect of eliminating inefficiency of scheduling due to personal judgment. The system realizes operation optimization of the entire factory by a computer science approach.

The learning and optimization unit has a function of continuously learning a performance change after measure implementation, and optimizing content and timing of a measure proposal. For example, when a failure risk is significantly reduced in a robot group in which immediate maintenance upon abnormal vibration detection has been implemented in the past, the same measure is preferentially proposed to a robot having a similar tendency. Conversely, when a specific measure does not show an effect, the generative AI analyzes a reason thereof, and automatically selects another measure. Implementation timing and a combination of measures are also optimized. Various indexes such as real-time site data, feedback from workers, a quality inspection result, a downtime record, the number of trouble reports, and discussion content in a site meeting are used for measuring an effect of a measure. Specific examples of a prompt text to be read by the generative AI include “When a ratio of a failure risk being reduced is high among robots for which a measure A has been implemented in the past six months, preferentially propose the measure A to a robot having a similar profile”. Specifically, the learning and optimization unit implements an online learning algorithm. The system continuously collects an execution log of a measure and time-series data indicating a subsequent change in an equipment state. The system accumulates the collected data as an evaluation data set on a memory. The system calculates a difference between a predicted risk score before measure execution and an actual state change after measure execution. The system feeds back this difference as a reward signal to a reinforcement learning model. The system dynamically updates a weight of a neural network of a decision-making engine using a policy gradient method. The system also periodically executes fine-tuning of a large language model. The system adds text feedback from a worker and a text of a trouble report as a new learning corpus. The system efficiently updates only a specific parameter layer of the large language model using a low-rank adaptation method. The system adapts the latest situation of a site and a specific technical term to the model while suppressing consumption of a calculation resource. The system executes a causal inference algorithm in order to quantify an effect of a measure. The system adjusts a confounding factor between a group in which a measure is implemented and a group in which a measure is not implemented using propensity score matching. The system statistically estimates a pure causal effect of a measure. The system incorporates a numerical value of the estimated causal effect into calculation of a priority score at the time of a next measure proposal. The system automatically lowers a selection probability of a measure A, for example, when a causal effect score of the measure A falls below a threshold of 0.5. The system executes these learning processes in a background asynchronous thread. The system does not affect latency of main inference processing. The system is applied to a use case requiring continuous improvement such as maintenance of a semiconductor manufacturing apparatus and engine maintenance of an aircraft. The system brings about a technical effect of autonomously adapting to an environmental change and improving prediction accuracy of the system and quality of a proposal over time. The system fundamentally solves a problem of obsolescence into which a static rule-based system falls.

The user interface unit has a function of enabling users such as a site manager, a maintenance person in charge, and a worker to browse and operate an analysis result and a measure proposal transmitted from the server on a dashboard, a notification screen, a report screen, and the like. The site manager uses a dashboard capable of overlooking a risk distribution of the entire factory, a trend by line, and a transition of a measure implementation history and an effect, the maintenance person in charge uses a screen capable of confirming a risk factor and a measure proposal of an individual robot or equipment, a past response history, and details of a measure effect, and the worker uses a screen capable of browsing and inputting his/her own work assignment, health condition, recommended break/safety measure, and report/feedback of a site trouble. Operation content from the terminal is transmitted to the server, and is reflected in real time in the AI analysis and the measure proposal from the next time onward. Specifically, the user interface unit adopts a single-page application architecture. The present system establishes an always-connected bidirectional communication channel with the server using a WebSocket protocol. The present system receives update data in a JSON format push-distributed from the server in real time. The present system redraws only a necessary part of the screen at high speed using a virtual document object model. The present system renders a digital twin model of the factory on a browser using a 3D graphics library. The present system dynamically changes a color of a corresponding part on the 3D model in accordance with a risk score of each equipment. For example, the present system blinks and displays a part having a risk score exceeding 0.8 in red. The present system detects a user's click event, and pop-up displays a detailed time-series graph and a factor analysis result of the corresponding part. The present system has a function of processing an input from a camera or a microphone of the terminal. The present system transmits an image tensor of an abnormal part at the site photographed by the worker to the server. The present system converts a voice report of the worker into text data and transmits the text data using a voice recognition application programming interface. The present system executes an edge AI model on the terminal side, and performs lightweight filtering processing on the data before transmission. For example, the present system detects an unclear image or a noisy voice, and displays an alert prompting re-input on the terminal. Thereby, the present system ensures quality of the data transmitted to the server. The present system implements a role-based access control mechanism in a front end. The present system verifies an authority token of a logged-in user, and dynamically switches a displayable component. The present system is applied to a use case such as a monitoring room of a smart factory or a tablet terminal carried by a worker. The present system brings about a technical effect of realizing intuitive and highly immediate information transmission. The present system significantly reduces a cognitive load in a human-machine interface.

In this way, the system according to the present embodiment includes the data integration unit, the AI analysis unit, the measure proposal unit, the learning and optimization unit, and the user interface unit, and each unit cooperates with each other to realize integration, analysis, measure generation, learning optimization, and visualization of diverse data with the generative AI as a core, thereby enabling innovative efficiency improvement and optimization of the entire factory operation. Specifically, the present system operates on a container orchestration platform based on a microservices architecture. The present system deploys each processing unit as an independent container image. The present system constantly monitors a load status of the entire system by a monitoring agent. When an inference queue of a specific processing unit, for example, the AI analysis unit, stays exceeding a threshold value, the present system automatically horizontally scales out the number of replicas of the container. The present system evenly distributes traffic to the added container group using a load balancer. When the processing load decreases, the present system automatically terminates a surplus container and releases a computational resource. The present system uses a lightweight remote procedure call protocol for communication between the microservices. The present system minimizes overhead of data serialization and deserialization. The present system introduces a distributed tracing system, and visualizes latency when a request passes through each processing unit. The present system identifies processing that becomes a bottleneck, and automatically executes an optimization routine. The present system applies tensor parallelism and pipeline parallelism technologies in inference processing of a large language model. The present system divides and arranges huge model parameters in memories of a plurality of graphics processing units. Thereby, the present system enables high-speed inference of a large-scale model that does not fit in a memory of a single device. The present system is applied to a large-scale use case such as an integrated production management system of a multinational corporation having a global supply chain network. The present system brings about a technical effect of dramatically improving availability, scalability, and fault tolerance of the system. The present system goes beyond mere business automation and realizes advanced optimization at a computer architecture level.

### Implementation Steps

### Step 1: Collection and Integration of Multidimensional Site Data

A wide variety of data relating to robots, equipment, workers, a site environment, and a supply chain in a factory is automatically and periodically collected, and centrally integrated into a database by linking the data with a common key such as a robot ID, an equipment ID, a worker ID, a work instruction ID, and a product lot number. For example, operation logs (operation time, number of stops, error occurrence history, power consumption, sensor values such as temperature, vibration, and current), maintenance histories (inspection date, replaced part, repair content, maintenance person in charge, part replacement cycle), abnormality detection logs (sensor abnormality, temperature abnormality, vibration abnormality, AI abnormality score), work instruction histories (work content, work completion time, work interruption history, work priority), quality inspection data (inspection result, defect rate, robot ID at the time of inspection, determination by image inspection AI), site environment sensor data (temperature, humidity, dust concentration, noise level, illuminance, CO2 concentration), health and safety data of workers (vital data, work time, break acquisition status, fatigue score, health checkup result), site communication histories (chat content, trouble report, improvement proposal), external supply chain information (part delivery delay, inventory status, delivery date change, supplier evaluation), and the like are comprehensively acquired. Specifically, the present system establishes communication with various sensors and control devices via an edge gateway device. The present system acquires time-series data in units of milliseconds from a programmable logic controller using an OPC-UA protocol. The present system temporarily stores the acquired raw data in a ring buffer on a memory. The present system converts high-frequency vibration data into spectrum data in a frequency domain by fast Fourier transform using a data sampling module. The present system outputs the converted data as a one-dimensional floating-point array. The present system receives a video stream from a network camera using an RTSP protocol. The present system extracts frames from the video stream at regular intervals, and generates a three-dimensional RGB image tensor. The present system acquires structured data of the supply chain in a JSON format from an enterprise resource planning system via a RESTful application programming interface. The present system publishes these heterogeneous data to a specific topic of a distributed streaming platform. The present system asynchronously reads data from each topic in a subscriber module. The present system writes the data to a relational database and a time-series database using a time stamp and various IDs as a composite primary key in a data integration engine. The present system applies batch insert processing in write processing to reduce an IO load of the database. The present system models a complex dependency relationship among equipment, a worker, and a product lot as a network structure of nodes and edges using a graph database. For example, the present system holds traceability information indicating which robot processed a specific part lot and which worker inspected the specific part lot in a graph structure. The present system is applied to a use case where a wide variety of data sources exist, such as an automobile assembly line or a food processing factory. The present system brings about a technical effect of minimizing a data collection delay and providing highly fresh data to subsequent analysis processing. The present system physically and logically destroys a data silo.

### Step 2: Data Preprocessing and Feature Value Generation

For the integrated data, preprocessing such as missing value imputation (imputing an unrecorded sensor value with a peripheral value or a past value), outlier removal (excluding a clearly abnormal temperature value, operation time, or noise value), quantification and category conversion (converting work content or an abnormality type into a category value, and quantifying a communication frequency), natural language processing (extracting and quantifying a sign of stress or poor coordination from a free description or chat content of a worker), smoothing and trend extraction of time-series data (detecting a moving average or a rapid change point of an operation time or an abnormality occurrence frequency), AI analysis of image data (extracting a defect detection score from a quality inspection image), and AI analysis of voice data (extracting an activity level or a tension level of a discussion from a recording of a site meeting) is automatically executed. Specific examples of a prompt sentence to be read by the generative AI include “Extract a sign of a failure risk or a quality risk from an operation log and an abnormality detection log of a robot A and chat content of a worker for the past week”, “Extract a sign of poor coordination or stress among workers from content of a site chat”, and “Extract a feature of a defective product from a quality inspection image, and analyze a correlation with an operating condition of a robot”. Specifically, the present system executes a preprocessing pipeline as a plurality of parallel worker processes. In the missing value imputation, the present system searches for a similar data point in a multidimensional feature space using a k-nearest neighbor algorithm. The present system calculates a weighted average of the searched neighboring points, and substitutes the weighted average into a missing part. In the outlier removal, the present system calculates a Mahalanobis distance, and flags a data point exceeding a statistical threshold value as noise. In a natural language processing module, the present system inputs text data of a chat to a morphological analyzer. The present system divides the text into an array of tokens. The present system inputs the token array to a pre-trained transformer model, and generates a 768-dimensional sentence embedding vector. The present system outputs a continuous value score from 0 to 1 indicating a stress level from the sentence embedding vector using a sentiment analysis classifier. In an image analysis module, the present system inputs an image tensor of a quality inspection to a convolutional neural network of a ResNet architecture. The present system extracts a 2048-dimensional image feature vector from a final pooling layer of the network. In a voice analysis module, the present system converts voice waveform data into a two-dimensional array of mel-frequency cepstral coefficients. The present system inputs the converted array to a recurrent neural network, and extracts an emotional feature of a voice. The present system combines these extracted feature vectors to construct a single high-dimensional feature value tensor. The present system executes a principal component analysis algorithm to reduce a dimension of the feature value tensor. The present system reduces a calculation cost of subsequent inference processing by the dimension reduction. The present system writes the generated feature value tensor to a shared memory area. The present system is applied to a use case where multimodal data is generated, such as monitoring of a chemical plant or operator management of a large-scale call center. The present system brings about a technical effect of converting unstructured data into a structured vector processable by a machine learning model. The present system completely eliminates a human resource required for data preprocessing.

### Step 3: Risk Prediction and Factor Extraction by Generative AI

With the preprocessed integrated data as an input, a failure occurrence probability, a quality defect occurrence risk, and a work efficiency reduction risk within the next one week of each robot or equipment are calculated as a score from 0 to 1 by a machine learning model utilizing the generative AI. The model automatically optimizes multidimensional feature values such as an operation pattern, an abnormality detection log, a site environment, a state of a worker, a supply chain status, a work instruction history, quality inspection data, and a communication history using a past failure/defect occurrence history as teacher data, and performs risk prediction. The generative AI is also utilized for feature value selection of the model, hyperparameter optimization, ensemble learning, automatic selection of an abnormality detection algorithm, factor extraction by explainable AI technology, and the like. Specific examples of a prompt sentence to be read by the generative AI include “Extract a failure risk score and three main risk factors of a robot B from the following integrated data. Input: operation time increase, frequent abnormal vibration, unreplaced consumable part, site temperature rise”. Specifically, the present system executes a hybrid model combining a gradient boosting decision tree and a deep neural network in an inference engine. The present system passes the high-dimensional feature value tensor generated in the preprocessing step to an input interface of the present model. The present system divides the input tensor into a plurality of subnetworks and processes the subnetworks in parallel. The present system inputs a time-series feature value to a one-dimensional convolutional layer, and extracts a temporal local pattern. The present system inputs the extracted pattern to a long short-term memory layer, and models a long-term dependency relationship. The present system applies a sigmoid activation function through a fully connected layer. The present system generates an array of probability scores from 0.0 to 1.0 for each risk category as an output. For example, the present system outputs a numerical array of a failure probability of 0.92, a quality defect probability of 0.15, and a work efficiency reduction probability of 0.45 of the robot B. The present system executes a SHAP algorithm in factor extraction processing. The present system calculates a marginal contribution degree given to a final prediction score by each feature value. The present system identifies top three feature value indices having a high contribution degree. The present system embeds the identified indices and the prediction score into a prompt template of a large language model. The present system transmits an inference request to the large language model. The present system receives a factor analysis report in a structured JSON format from the large language model. For example, the present system outputs data “Factor 1: abnormal vibration of main spindle (contribution degree+0.35), Factor 2: rapid rise in site temperature (contribution degree+0.20), Factor 3: excess of bearing replacement cycle (contribution degree+0.15)”. The present system saves these output data in a prediction result table of the database. The present system is applied to a use case where a minute abnormality leads to a serious defect, such as a precision processing line of an aircraft part or a manufacturing process of a semiconductor wafer. The present system brings about a technical effect of providing explainability based on a mathematical basis to a prediction result of AI that is likely to become a black box. The present system improves reliability of a site person in charge on the AI.

### Step 4: Automatic Proposal of Optimal Measure

Based on an output result of the AI analysis unit, the generative AI automatically proposes an optimal maintenance plan, work assignment, and site improvement measure for individual robots, equipment, workers, and the entire site. For example, for a robot A, immediate maintenance and operation stop are recommended because operation under abnormal vibration and a high-temperature environment continues, for the robot B, implementation of preventive maintenance and adjustment of an operation load are recommended because an operation time tends to increase and there is no part replacement history, and for a robot C, normal operation and periodic inspection are recommended because a risk is particularly low. For a worker D, a review of work assignment and an increase in break time are proposed because a fatigue score is high, and for the entire site, site improvement measures such as a review of an operation schedule of an entire line because high-risk robots are concentrated on a specific line, a review of a work procedure in a corresponding time zone because a quality defect rate increases in a specific time zone, an increase in a replacement frequency of workers, strengthening of air conditioning of a site environment, diversification of part procurement sources against a delivery delay of a supply chain, an early alert notification to a site leader, and risk sharing at a site meeting are proposed. Specific examples of a prompt sentence to be read by the generative AI include “Failure risk score of robot A: 0.85, main factors: frequent abnormal vibration, site temperature rise, unreplaced consumable part. Generate three optimal maintenance proposals”. Specifically, the present system executes processing integrating a rule-based constraint solver and a large language model in a measure generation module. The present system receives the risk score array and the factor contribution degree data output from the AI analysis unit as an input. First, the present system excludes a physically unexecutable measure from a search space using the constraint solver. For example, the present system deletes a maintenance plan using a replacement part having no inventory from candidates. The present system generates a filtered list of executable measure candidates. The present system formats this list and context data of a current site as an input prompt of the large language model. The present system adds success probability data of a measure in a past similar event to the prompt. The present system generates an expected effect score and text of an execution procedure for each measure candidate using the large language model. The present system generates a JSON object including a prioritized list of measures as an output. For example, the present system outputs data “Proposal 1: immediate stop of robot A and replacement of main spindle bearing (expected effect score: 0.95), Proposal 2: reduction of operation speed of robot A to 50 percent and inspection in next shift (expected effect score: 0.60)”. The present system executes an API call to a production scheduler system of the factory based on the generated measure data. The present system triggers dynamic recalculation of a production plan. The present system transmits a break instruction or a work place change instruction as a push notification to a smart watch of the worker. The present system is applied to a use case where complex system control is required, such as blast furnace operation of a steelworks or air conditioning/power supply management of a large-scale data center. The present system brings about a technical effect of instantaneously evaluating a multidimensional constraint condition and automatically generating a totally optimized action plan. The present system completes planning work performed by a human manager over several hours in units of milliseconds.

### Step 5: Measure Implementation and Effect Feedback

Via the user interface unit, users such as a site manager, a maintenance person in charge, and a worker are enabled to browse and operate an analysis result and a measure proposal transmitted from the server on a dashboard, a notification screen, a report screen, and the like. The user inputs feedback of measure implementation, a site trouble report, a reaction to a measure proposal, an improvement proposal from a worker, and the like from the terminal, and transmits them to the server. Thereby, an implementation status and effect data of the measure are collected in real time, and are reflected in the AI analysis and the measure proposal from the next time onward. Specifically, the present system implements an event-driven feedback loop architecture. The present system asynchronously captures a user's operation event in the user interface unit on the terminal. For example, when the user clicks a “measure execution” button on the dashboard, the present system generates an event payload including a time stamp thereof, a target equipment ID, and a measure ID. The present system transmits the generated payload to an API endpoint of the server via an HTTPS protocol. The present system receives a request on the server side, and enqueues the request in a messaging queue. The present system dequeues a message from the queue using a background worker process, and inserts a record into a measure history table of the database. At the same time, the present system switches a monitoring mode of sensor data of the target equipment to a high-frequency sampling mode. The present system records a physical state change of the equipment immediately after implementation of the measure with a resolution in units of milliseconds. The present system receives text feedback in a natural language input from the terminal by the worker. The present system inputs the text data to a natural language processing module, and extracts a positive or negative sentiment score. The present system stores the extracted sentiment score as numerical data in the database. The present system automatically labels these feedback data as a teacher data set for next batch learning processing. For example, when abnormal vibration decreases below a threshold value after execution of the measure, the present system records the measure as a “success” label. The present system is applied to a use case where a dynamic environmental change is severe, such as management of a picking robot group in a distribution warehouse or heavy machinery fleet management at a construction site. The present system brings about a technical effect of synchronizing an action in a physical world and a result thereof to a digital space without delay. The present system establishes a data pipeline for constantly adapting a prediction model of the system to the latest site state.

### Step 6: Learning and Optimization of Measure Effect

The learning and optimization unit continuously learns a performance change (failure risk reduction, quality defect rate reduction, work efficiency improvement, downtime shortening, site trouble reduction, worker health index improvement, etc.) after implementation of the measure, and optimizes content and timing of a measure proposal. For example, when a failure risk is significantly reduced in a robot group in which immediate maintenance at the time of abnormal vibration detection was implemented in the past, the same measure is preferentially proposed to a robot having a similar tendency. Conversely, when a specific measure does not show an effect, the generative AI analyzes a reason thereof, and automatically selects another measure. Specific examples of a prompt sentence to be read by the generative AI include “When a ratio of a reduced failure risk is high among robots for which a measure A was implemented in the past six months, preferentially propose the measure A to a robot having a similar profile”. Specifically, the present system executes a proximal policy optimization method, which is a kind of deep reinforcement learning algorithm, in the learning and optimization unit. The present system reads a measure history table and time-series data of an equipment state accumulated in the database. The present system extracts a state vector before implementation of the measure, an action vector of the selected measure, and a reward scalar value based on a state change after implementation of the measure. The present system stores a tuple of these data in an experience replay buffer. The present system randomly samples a mini-batch from the buffer, and updates weight parameters of an actor network and a critic network. The present system fine-tunes the parameters in a direction of maximizing an expected reward using a gradient descent method. When a reward of a specific measure continuously becomes a negative value, the present system applies a penalty function that intentionally reduces a selection probability of the measure. The present system automatically executes root cause analysis of a failed measure using a large language model. The present system inputs context data of a failure case as a prompt, and generates text of a reason for failure and an alternative plan. The present system adds the generated alternative plan to the reinforcement learning model as a candidate for a new action space. The present system distributedly executes update processing of the model on a parallel computing cluster of graphics processing units. The present system completes relearning using millions of log data within several minutes. The present system hot-deploys a weight file of the updated model to an inference server in a production environment without stopping. The present system is applied to a use case where continuous performance improvement is indispensable, such as turbine control of a wind power plant or fleet management of an autonomous vehicle. The present system brings about a technical effect that the system itself learns from experience without human intervention and autonomously improves accuracy of decision making. The present system realizes more advanced and optimized control as an operation period becomes longer.

### Specific Use Case

For example, a case will be described in which the system of the present invention is applied to a production line in an electronic component assembly factory where a large number of robot arms, transport devices, inspection devices, workers, site environment sensors, and external supply chain management systems exist. The data integration unit automatically and periodically collects operation logs (operation time, number of stops, error occurrence history, power consumption, and sensor values such as temperature, vibration, and current) from each robot arm, operation data such as the number of transports, transport errors, transport speed, and load weight from the transport devices, quality inspection results, defect rates, determination results of image inspection AI, and environmental conditions during inspection from the inspection devices, work time, break acquisition status, vital data, near-miss reports, and stress check results from the workers, temperature, humidity, dust concentration, noise level, illuminance, CO2 concentration, air conditioning operation status, and ventilation frequency from the site environment sensors, and information such as part delivery delays, raw material inventory status, delivery date changes, supplier evaluations, and logistics troubles from the supply chain management system, respectively, and centrally integrates the data into a database by linking the data with a common key such as a robot ID, an equipment ID, a worker ID, a work instruction ID, and a product lot number. Furthermore, communication histories such as site chats, trouble reports, improvement proposals, and minutes of site meetings are also targeted for collection. Specifically, the present system deploys lightweight edge agent software to each node of the electronic component assembly line. The present system samples pulse signals and current waveform data of an encoder in microseconds from a servo motor controller of the robot arm. The present system acquires a time-series array of position coordinate data and velocity vectors from a programmable logic controller of the transport device. The present system captures a 4K resolution image tensor indicating a surface mount state of a printed circuit board at a frame rate of 60 fps from a high-resolution camera of the inspection device. The present system receives vital data such as a heart rate and a skin temperature from a wearable device worn by the worker via a low power consumption wireless communication protocol. The present system collects environmental data from a site environment sensor group via an IoT gateway by a lightweight messaging protocol. The present system periodically polls a Web API of the external supply chain management system to acquire inventory data in an XML format. The present system converts these wide variety of protocols and data formats into a single standardized JSON schema in the data integration unit. The present system caches the converted data in an in-memory data grid. The present system adds a high-precision time stamp synchronized by a network time protocol to each data record. The present system executes complex table join processing on a distributed relational database using the time stamp and various IDs. For example, the present system constructs a multidimensional data cube in which which robot arm assembled a specific board lot, and what the humidity of the site and the heart rate of the worker were at that time are completely linked. The present system is applied to a use case requiring extremely high traceability, such as a smartphone manufacturing factory and an assembly line of medical electronic equipment. The present system brings about a technical effect of exhaustively capturing and integrating all events in a physical space as digital data. The present system establishes a robust data foundation for subsequent advanced correlation analysis.

For the integrated data, preprocessing such as missing value imputation (imputing an unrecorded sensor value with a peripheral value or a past value), outlier removal (excluding a clearly abnormal temperature value, operation time, or noise value), quantification and category conversion (converting work content or an abnormality type into a category value, and quantifying a communication frequency), natural language processing (extracting and quantifying a sign of stress or coordination failure from a free description or chat content of the worker), smoothing and trend extraction of time-series data (detecting a moving average or a rapid change point of operation time or abnormality occurrence frequency), AI analysis of image data (extracting a defect detection score from a quality inspection image), and AI analysis of voice data (extracting an activity level or a tension degree of a discussion from a recording of a site meeting) is automatically executed. The generative AI analyzes unstructured data and complex correlations using prompts such as, for example, “Extract signs of a failure risk and a quality risk from the operation log and abnormality detection log of the robot arm A and the chat content of the worker for the past week,” “Extract signs of coordination failure and stress among workers from the content of the site chat,” and “Extract characteristics of a defective product from the quality inspection image and analyze the correlation with the operation conditions of the robot.” Specifically, the present system executes batch processing and stream processing using a distributed processing framework on the constructed multidimensional data cube. In the missing value imputation, the present system estimates a smooth curve of the time-series data using a spline interpolation algorithm, and calculates a numerical value of a missing data point. In the outlier removal, the present system performs density-based clustering of the data using a local outlier factor method, and identifies and deletes isolated noise data. In the category conversion, the present system converts a categorical variable of a character string into an array of binary vectors processable by a machine learning model using a one-hot encoding method. In the natural language processing, the present system uses a model of a bidirectional transformer encoder architecture. The present system takes text data of a chat as an input, and outputs a 768-dimensional embedding vector considering the context of each word. The present system identifies which word in the text strongly contributed to the determination of stress or coordination failure by analyzing a weight of an attention mechanism. In the trend extraction of time-series data, the present system applies an autoregressive integrated moving average model, and separates a seasonal variation component and a trend component. In the analysis of image data, the present system executes a model based on a single-pass object detection algorithm. The present system takes an image tensor as an input, and outputs bounding box coordinates of a defective part and a confidence score. The present system combines various feature vectors generated by these preprocessings as a single huge feature matrix. The present system inputs a combination of statistical summary data of this feature matrix and a natural language prompt to a large language model. The present system causes the large language model to output a text report explaining a hidden correlation between data and a weighting coefficient vector for subsequent processing. The present system is applied to a use case such as automation of a visual inspection process of precision parts and digitization of tacit knowledge of a skilled worker. The present system brings about a technical effect of mapping noisy raw site data to a high-purity and information-rich feature space. The present system significantly improves prediction accuracy and a convergence speed of an inference model.

The AI analysis unit calculates a failure occurrence probability, a quality defect occurrence risk, and a work efficiency reduction risk within the next one week of each robot and equipment as a score from 0 to 1 by a machine learning model utilizing the generative AI with the preprocessed integrated data as an input. For example, when the operation time of the robot arm A rapidly increases, abnormal vibration frequently occurs, and the robot arm A continuously operates in a state where the site temperature is high, a failure risk score is calculated to be high. When the transport device B exceeds a replacement cycle of a consumable part and an AI abnormality detection score is increasing, it is determined that the necessity of preventive maintenance is high. When the worker C has a high fatigue score, insufficient break acquisition, and many trouble reports in the site chat, a work efficiency reduction risk of the robot or equipment in charge is calculated to be high. In the quality inspection data, when a defect rate is high in a product handled by a specific robot, a correlation with the operation conditions of the robot, the skill of the worker, and the site environment is automatically extracted. Specific examples of the prompt sentence to be read by the generative AI include “Extract a failure risk score and three main risk factors of the robot arm A from the following integrated data. Input: operation time increase, abnormal vibration frequent occurrence, consumable part unreplaced, site temperature rise.” Specifically, the AI analysis unit executes an inference engine adopting a graph neural network architecture. The present system receives the feature matrix generated in the preprocessing step and an adjacency matrix indicating a relationship between equipment and workers as an input. The present system aggregates the feature of each node with the feature of an adjacent node using a graph convolutional layer. For example, the present system mathematically convolves temperature data of an adjacent site environment sensor and fatigue score data of the worker C in charge with respect to the node of the robot arm A. The present system repeats this message passing processing over a plurality of layers, and learns a high-order representation vector of each node. The present system inputs the learned representation vector to a fully connected layer, applies a softmax function, and outputs a final risk score. The present system generates a three-dimensional vector of a failure probability, a quality defect probability, and a work efficiency reduction probability for each node as output data. For example, the present system outputs a vector of 0.88, 0.45, and 0.20 for the robot arm A. At the same time, the present system analyzes a weight matrix of an attention mechanism, and identifies information of which adjacent node contributed most to an increase in the risk score. The present system incorporates the identified contribution degree data into an input prompt of a large language model. The present system converts the numerical risk score and contribution degree data into a natural language diagnostic report easy for a human to understand using the large language model. For example, the present system outputs a text “The failure risk of the robot arm A has reached 88 percent. The main factor is a combined effect of inappropriate operation due to fatigue of the worker C and overheating of the motor accompanying a rise in the site temperature.” The present system is applied to a use case in which a plurality of factors are complexly intertwined, such as an automobile engine assembly line and a semiconductor exposure process. The present system brings about a technical effect of accurately predicting a chain risk hidden in the entire system, which cannot be discovered only by single equipment data. The present system dramatically reduces a large amount of false positives issued by a conventional threshold-based alert system.

The measure proposal unit automatically proposes an optimal maintenance plan, work assignment, and site improvement measure for individual robots, equipment, workers, and the entire site based on an output result of the AI analysis unit. For example, for the robot arm A, immediate maintenance and operation stop are recommended because operation under abnormal vibration and a high-temperature environment continues, for the transport device B, implementation of preventive maintenance and adjustment of an operation load are recommended because the operation time tends to increase and there is no part replacement history, and for the inspection device C, normal operation and periodic inspection are recommended because the risk is particularly low. For the worker D, a review of work assignment and an increase in break time are proposed because the fatigue score is high, and for the entire site, site improvement measures such as a review of an operation schedule of the entire line because high-risk robots are concentrated on a specific line, a review of a work procedure in a corresponding time zone because a quality defect rate increases in a specific time zone, an increase in a replacement frequency of workers, strengthening of air conditioning of the site environment, diversification of part procurement sources against a delivery delay of the supply chain, an early alert notification to a site leader, and risk sharing at a site meeting are proposed. Specific examples of the prompt sentence to be read by the generative AI include “Failure risk score of robot arm A: 0.85, main factors: abnormal vibration frequent occurrence, site temperature rise, consumable part unreplaced. Generate three optimal maintenance proposals.” Specifically, the measure proposal unit includes a hybrid optimization engine combining an evolutionary algorithm and a large language model. The present system receives the risk score vector and the factor contribution degree data output from the AI analysis unit. The present system encodes a combination of possible measures as a gene sequence, and generates an initial population. The present system calculates a fitness function on a simulation environment for each individual. The present system uses a mathematical formula aiming at maximizing a total production amount of a factory and minimizing a total maintenance cost as the fitness function. The present system iteratively applies genetic operators of selection, crossover, and mutation, and searches for an optimal combination of measures with high fitness. The present system decodes a parameter vector of the searched optimal solution, and converts it into a list of specific actions. The present system configures this action list and current state data of the factory as an input prompt of the large language model. The present system generates structured JSON data describing a specific execution procedure, a necessary resource, and an expected effect of each action using the large language model. For example, the present system outputs data “Target: robot arm A, Action: immediate stop and cooling, Necessary resource: one maintenance person in charge and cooling fan, Expected effect: complete avoidance of motor burnout.” The present system transmits the generated measure data to a manufacturing execution system of the factory via an API. The present system directly updates a work instruction table in a database of the manufacturing execution system. At the same time, the present system transmits a push notification attached with a specific work procedure manual to a mobile terminal of a related worker. The present system is applied to a use case in which a large number of devices are interlocked, such as valve control of a chemical plant and conveyor network control of a large-scale logistics center. The present system brings about a technical effect of computationally deriving not local optimization but global optimization of the entire factory. The present system solves a complex scheduling problem exceeding human cognitive limits in real time.

The user interface unit enables a user such as a site manager, a maintenance person in charge, and a worker to browse and operate an analysis result and a measure proposal transmitted from the server on a dashboard, a notification screen, a report screen, and the like. The site manager uses a dashboard capable of overlooking a risk distribution of the entire factory, a trend by line, and a transition of a measure implementation history and an effect, the maintenance person in charge uses a screen capable of confirming a risk factor and a measure proposal of an individual robot or equipment, a past response history, and details of a measure effect, and the worker uses a screen capable of browsing and inputting his/her own work assignment, health condition, recommended break/safety measure, and report/feedback of a site trouble. Operation content from the terminal (feedback of measure implementation, site trouble report, reaction to measure proposal, improvement proposal from worker) is transmitted to the server, and is reflected in AI analysis and measure proposal from the next time onward in real time. Specifically, the user interface unit is constructed using a front-end framework based on a reactive programming paradigm. The present system establishes a unidirectional real-time data stream using a server-sent events protocol between a message broker on the server side and a client application on the terminal side. Every time a new risk score or measure proposal is calculated in the server, the present system immediately push-delivers the JSON payload to the client. The present system stores received data in a memory using a state management library on the client side, and asynchronously re-renders a component of the user interface. The present system superimposes and displays a risk state of each equipment as a heat map on a floor map of the factory using WebGL technology. The present system highlights high-risk equipment with a red gradation, and calls visual attention. When the user taps a specific equipment icon, the present system acquires detailed time-series log data and a text report of factor analysis from the server via a REST API, and displays them on a modal window. The present system utilizes position information data acquired from a GPS sensor or an indoor positioning system of the terminal. When the worker approaches high-risk equipment, the present system activates a vibration function and a warning sound of the terminal. The present system provides an input assistance function using natural language processing in feedback input from the worker. When the worker inputs text, the present system suggests and displays a report sentence of a past similar trouble, and reduces an input load. The present system transmits the input text data and image data to an upload endpoint of the server as multipart form data. The present system is applied to a use case in which a site situation changes momentarily, such as hygiene management of a food factory and safety management of a construction site. The present system brings about a technical effect of minimizing time from data to insight and then to action. The present system seamlessly couples the site worker and an AI engine on a cloud.

A learning/optimization unit continuously learns a performance change (failure risk reduction, quality defect rate reduction, work efficiency improvement, downtime shortening, site trouble reduction, worker health index improvement, etc.) after implementation of a measure, and optimizes content and timing of a measure proposal. For example, when a failure risk is significantly reduced in a robot group in which immediate maintenance at the time of abnormal vibration detection was implemented in the past, the same measure is preferentially proposed to a robot having a similar tendency. Conversely, when a specific measure does not show an effect, the generative AI analyzes the reason, and automatically selects another measure. Specific examples of the prompt sentence to be read by the generative AI include “When a ratio of a reduced failure risk is high among robots for which a measure A was implemented in the past six months, preferentially propose the measure A to a robot having a similar profile.” Specifically, the learning/optimization unit executes an automated machine learning framework integrated into a pipeline of continuous integration and continuous delivery. The present system periodically joins a measure history table and an equipment state table of the database, and calculates a difference vector indicating a state change before and after execution of the measure. The present system dynamically generates a new teacher data set using this difference vector as an objective variable and content of the measure and context data at the time of execution as explanatory variables. The present system recalculates a reward function parameter of a reinforcement learning model of the measure proposal unit using the generated data set. The present system searches a hyperparameter space of the model using a Bayesian optimization algorithm, and identifies an optimal parameter set that minimizes a prediction error. When a specific measure cannot achieve an expected effect, the present system flags the event as an abnormal value. The present system inputs data of the flagged event to the large language model, and causes the large language model to infer a root cause of failure. The present system causes the large language model to output a text report such as “The cause of failure of the measure A is an expansion of a tolerance of a part due to aged deterioration of target equipment, and a standard maintenance procedure was insufficient,” and a logical expression of a new constraint condition. The present system automatically adds this logical expression to a constraint solver of the measure proposal unit, and prevents a proposal of an inappropriate measure in a future similar case. After the update of the model is completed, the present system operates a new model in parallel in a production environment using a shadow deployment method. The present system compares inference results of the old and new models, confirms that the performance of the new model is statistically significantly improved, and then completely switches traffic to the new model. The present system is applied to a use case requiring extremely high reliability, such as part manufacturing in the aerospace industry and a software update of an autonomous driving vehicle. The present system brings about a technical effect of accumulating experience data obtained through operation of the system as knowledge, and permanently evolving the performance of the model. The present system breaks through a limit of a static algorithm, and realizes a self-organizing intelligent system.

In this way, the system of the present invention makes it possible to comprehensively integrate diverse data in a factory, predict a failure, quality, and work efficiency risk with high accuracy by utilizing generative AI, automatically propose an individually optimal measure, and continuously optimize the performance of the entire site. Specifically, the present system operates on a parallel computing cluster composed of a plurality of computing nodes. The present system implements a hybrid artificial intelligence model integrating a long short-term memory network for time-series data processing and a transformer architecture for natural language processing. The data integration unit converts raw data acquired from various sensors in the factory into a high-dimensional numerical vector. The data integration unit executes linear interpolation of a missing value and normalization processing. The hybrid artificial intelligence model receives preprocessed data as an input. The input data is, for example, 256-dimensional time-series array data. A specific example of the input data includes three-axis vibration data of a spindle motor of a manufacturing apparatus. A specific example of the input data includes temperature transition data of a cutting fluid. A specific example of the input data includes text embedding data obtained by vectorizing a past maintenance history. The hybrid artificial intelligence model extracts a hidden correlation between respective input features using a self-attention mechanism in a high-dimensional vector space. The hybrid artificial intelligence model executes a prediction calculation based on the extracted feature. The hybrid artificial intelligence model outputs a plurality of data as a calculation result. The output data is, for example, a floating-point score taking a range from 0 to 1. A specific example of the output data includes a failure probability score of a spindle bearing within the next 24 hours. A specific example of the output data includes a dimensional abnormality occurrence risk value of a product in the next lot. A specific example of the output data includes structured text data describing a recommended part replacement procedure. A subsequent processing unit of the present system compares the output failure probability score with a preset threshold value. When the score exceeds the threshold value, the subsequent processing unit transmits a control signal for immediate stop to a programmable logic controller of the corresponding manufacturing apparatus. At the same time, the subsequent processing unit transmits an alert notification including a recommended procedure to a mobile terminal of a maintenance person in charge. The learning unit calculates a cross-entropy error between an actual failure occurrence record and a prediction result. The learning unit dynamically updates a weight parameter of the model using an error backpropagation method. The learning unit adopts an adaptive moment estimation method as a gradient descent algorithm. The present system is fundamentally different from conventional rule-based processing depending on human rules of thumb. The present system executes complex pattern recognition in a high-dimensional space using a nonlinear function having millions of parameters. This configuration dramatically improves calculation efficiency. This configuration significantly improves prediction accuracy compared to a conventional method. The present system also supports an alternative configuration of executing a lightweight inference model on an edge device in order to reduce a communication load. A specific application field of the present system includes a manufacturing factory of a semiconductor wafer. A specific application field of the present system includes an automobile engine assembly line. The present system exhibits a remarkable technical effect of minimizing downtime and maximizing yield in these use cases.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

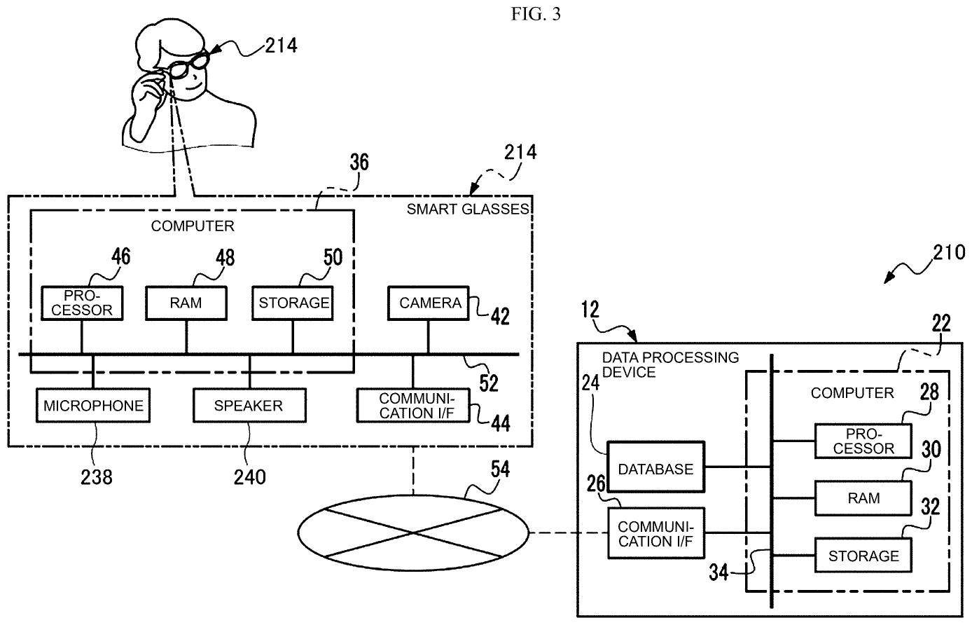

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

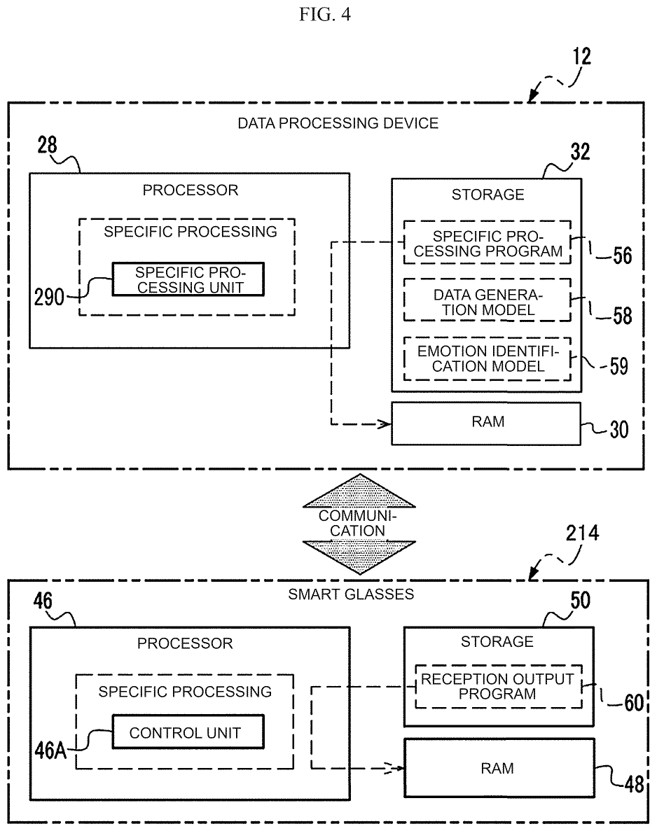

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

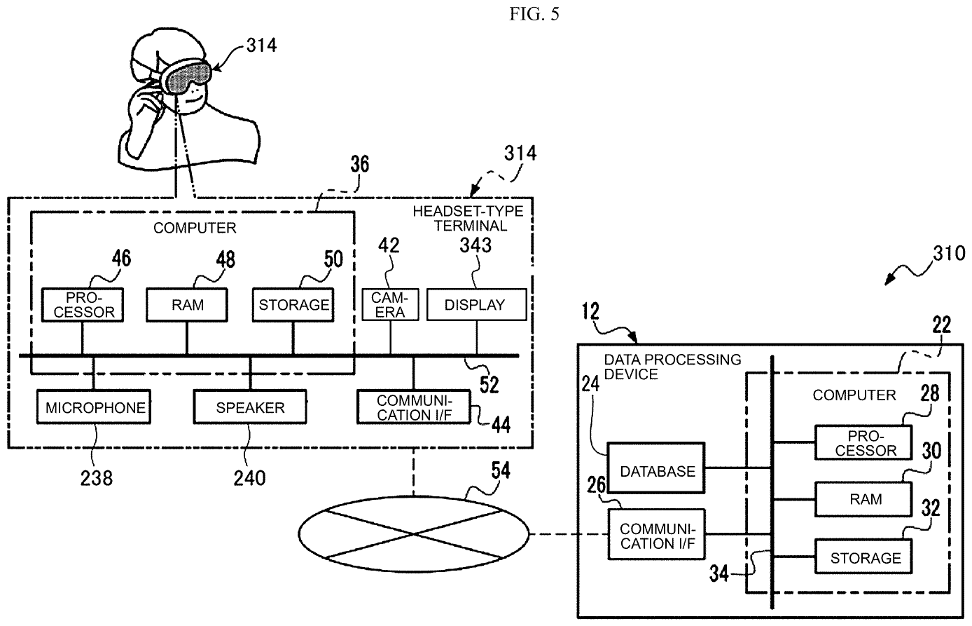

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

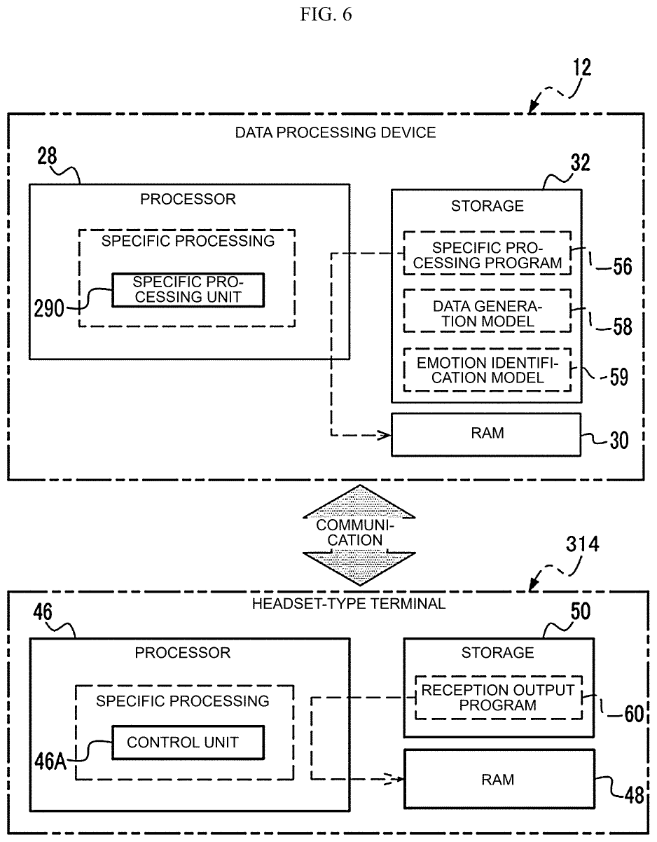

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

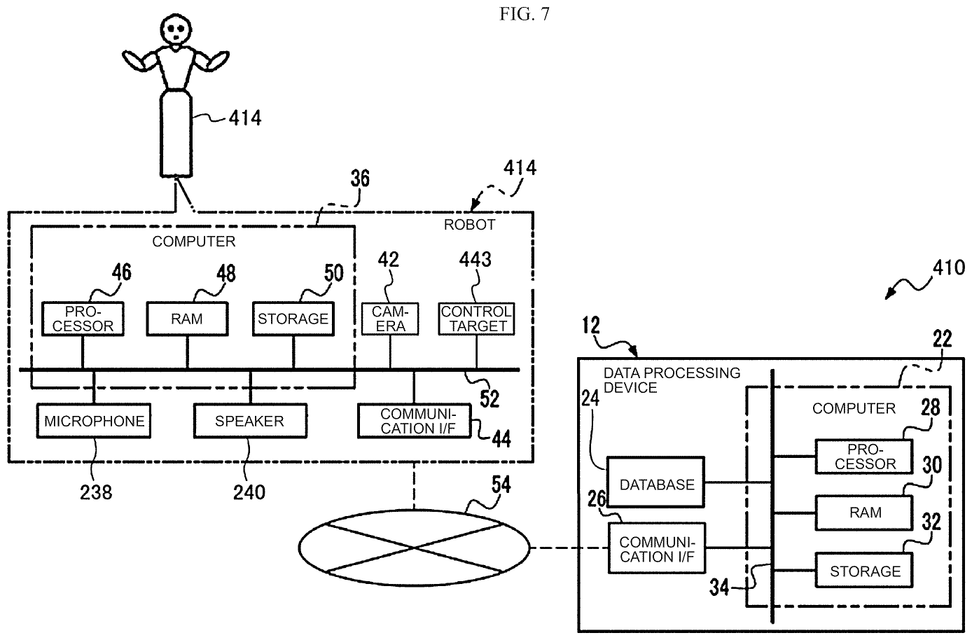

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

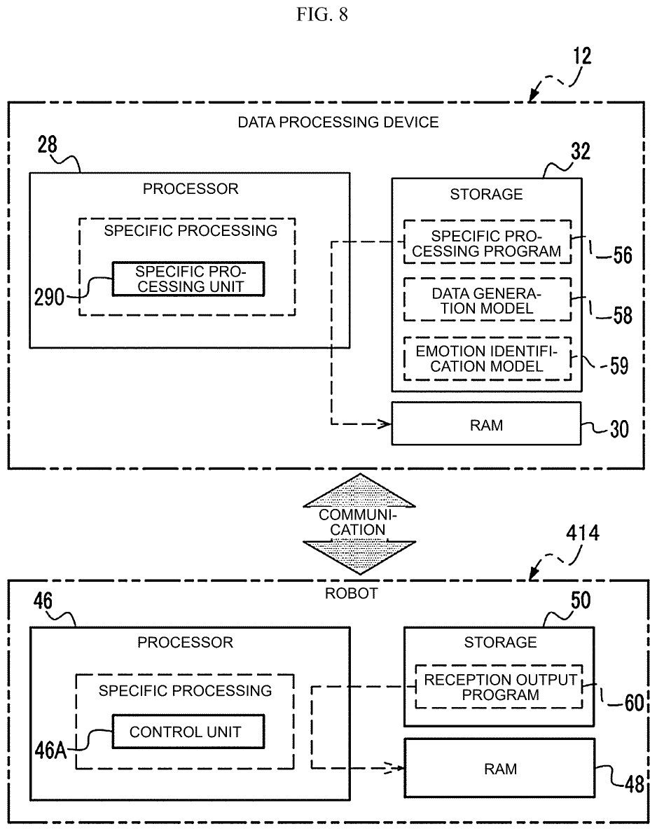

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

### Example 1

Since the flow of the specific processing is the same as that in Example 1 described in the first embodiment, the description thereof is omitted.

### Application Example 1

Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

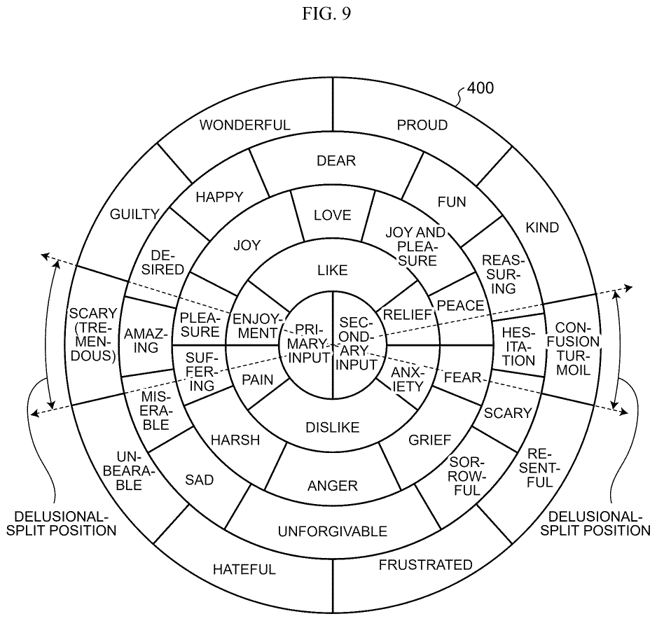

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https: //ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

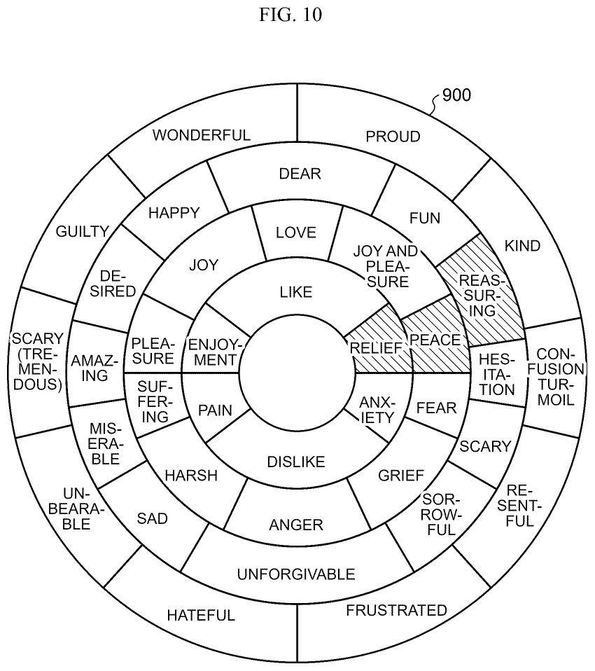

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A system comprising: a data integration unit configured to collect and integrate a wide variety of data relating to robots, equipment, workers, a site environment, and a supply chain in a factory; an AI analysis unit configured to predict a failure risk, a quality risk, and a work efficiency reduction risk of each robot and equipment with high accuracy by utilizing generative AI using the integrated data, and identify and explain a risk factor; and a measure proposal unit configured to automatically propose an optimal maintenance plan, work assignment, and site improvement measure for individual robots, equipment, workers, and the entire site based on a risk analysis result by the AI analysis unit, and visualize and notify information in real time to a site manager and an operation person in charge, wherein the data integration unit is configured to centrally integrate a plurality of types of data, such as operation logs, maintenance histories, abnormality detection logs, work instruction histories, quality inspection data, site environment sensor data, health and safety data of workers, site communication histories, and external supply chain information of the robots and the equipment, by linking the data with a common key such as a robot ID, an equipment ID, a worker ID, a work instruction ID, and a product lot number, and automatically execute preprocessing such as missing value imputation, outlier removal, quantification, category conversion, natural language processing, and smoothing and trend extraction of time-series data; the AI analysis unit is configured to calculate a failure risk score, a quality risk score, and a work efficiency reduction risk score of each robot and equipment by a machine learning model using the generative AI with the integrated data as an input, and further extract factors contributing to each score in order of importance by explainable AI technology; and the measure proposal unit is configured to automatically select and propose a specific work and maintenance proposal such as immediate maintenance, preventive maintenance, operation load adjustment, normal operation, and periodic inspection for individual robots and equipment based on the scores and a factor analysis result, visualize a risk distribution and a quality trend for the entire site in real time, extract an issue in a specific line or group, and notify the site manager and the operation person in charge of the issue.

### Supplementary Note 2

The system according to Supplementary Note 1, wherein the AI analysis unit is configured to capture a wide variety of environmental parameters such as temperature, humidity, dust concentration, noise level, illuminance, CO2 concentration, seat utilization rate, and in-office movement history as the site environment sensor data as the integrated data, and analyze the failure risk, the quality risk, and the work efficiency reduction risk including these data using the generative AI, and when an abnormal value or a risk sign is detected, the measure proposal unit is configured to automatically propose an alert notification and a site environment improvement measure.

### Supplementary Note 3

The system according to Supplementary Note 1, wherein the measure proposal unit is configured to learn a past maintenance implementation history and effect data thereof, a work assignment history of workers, and an implementation history and effect data of a site improvement measure by the generative AI, automatically select a maintenance plan, work assignment, and a site improvement measure estimated to have the highest effect for each robot, equipment, worker, or site, continuously optimize content and timing of a measure proposal, and further visualize a performance change after implementation of the measure in real time on a dashboard for the site manager and the operation person in charge.

What is claimed is:

1. A system comprising:
circuitry configured to:
receive, via a communication interface coupled to a packet-switched network, multi-source telemetry data from IoT sensor devices at a site and structured records from external data service systems, perform sampling rate conversion and noise filtering of the telemetry data at an edge gateway, and store the filtered telemetry data in a storage device;
apply preprocessing operations to the filtered telemetry data comprising missing value imputation, outlier removal, quantification of categorical values, and natural language processing of text fields to generate a preprocessed dataset;
apply a generative neural network model to the preprocessed dataset to generate an analysis output data record comprising a deviation score for each monitored entity identifier and a causal factor feature vector;
generate a measure proposal data record by applying the generative neural network model to the analysis output data record and reference records retrieved from a vector database by cosine similarity search; and
transmit the analysis output data record and the measure proposal data record to terminal devices via the communication interface.

2. The system according to claim 1, wherein the circuitry is configured to receive pulse signal data and current value data from encoder sensors and motor sensors at the site via an industrial Ethernet protocol, perform sampling rate conversion at the edge gateway to a standardized sampling rate, apply a noise filter to reduce high-frequency noise components, and transmit the filtered data to the cloud computing node via the communication interface.

3. The system according to claim 2, wherein the circuitry is configured to apply a one-dimensional convolutional neural network to time-series telemetry arrays to extract feature vectors, apply a long short-term memory network to the extracted feature vectors to generate multi-step ahead prediction values, and compute a reconstruction error score by comparing the prediction values against observed telemetry values as an anomaly indicator.

4. The system according to claim 3, wherein the circuitry is configured to apply an autoencoder model pre-trained on telemetry data representing normal site operating conditions to incoming telemetry arrays, compute reconstruction error scores, and generate an anomaly signal when a reconstruction error score exceeds an anomaly threshold parameter, incorporating the anomaly signal as an additional feature in the preprocessed dataset.

5. The system according to claim 1, wherein the circuitry is configured to apply a graph neural network to a relational graph constructed from the multi-source telemetry data, the relational graph comprising entity identifier nodes and interaction edges derived from co-occurrence patterns in the structured records, execute message passing operations between adjacent nodes, and incorporate the propagated node feature vectors in the analysis output data record generation.

6. The system according to claim 5, wherein the circuitry is configured to compute the deviation score for each entity identifier node by applying the generative neural network model to the propagated node feature vector and a baseline feature vector derived from historical telemetry data, and generate an anomaly indicator flag when the deviation score exceeds a deviation threshold parameter.

7. The system according to claim 1, wherein the circuitry is configured to apply the natural language processing model to text field data in the structured records comprising maintenance report text and operational log text to extract named entity labels, sentiment polarity scores, and event category labels, and incorporate the extracted labels as additional feature dimensions in the preprocessed dataset.

8. The system according to claim 7, wherein the circuitry is configured to generate the causal factor feature vector by applying the generative neural network model to the named entity labels, sentiment polarity scores, and event category labels extracted from the text field data alongside the anomaly indicator flags from the time-series analysis, and identify correlations between text-derived features and telemetry anomaly patterns.

9. The system according to claim 1, wherein the circuitry is configured to generate the measure proposal data record by constructing a retrieval-augmented generation prompt comprising the analysis output data record, top-ranked reference records retrieved from the vector database by cosine similarity search, and constraint parameters received from a terminal device, and generating an action sequence by autoregressive decoding conditioned on the prompt.

10. The system according to claim 9, wherein the circuitry is configured to apply a simulation model to each action sequence in the measure proposal data record to generate a projected outcome trajectory, rank action sequences by an aggregate projected improvement score, and transmit the ranked measure proposal data record with projected outcome trajectories to the terminal device.

11. The system according to claim 1, wherein the circuitry is configured to generate visualization output data from the analysis output data record comprising deviation score distribution charts, entity identifier ranking tables, and causal factor contribution diagrams, and transmit the visualization output data as a structured dashboard data record to terminal devices via the communication interface.

12. The system according to claim 1, wherein the circuitry is configured to collect data from external data service systems comprising industry trend feeds and environmental condition data via the communication interface, incorporate the collected external data as additional feature dimensions in the preprocessed dataset, and compare entity-level deviation scores against industry benchmark deviation scores to generate relative performance indicators.

13. The system according to claim 1, wherein the circuitry is configured to monitor deviation scores against configurable threshold parameters at a periodic update interval, generate an alert data record when a deviation score exceeds a high-priority threshold, apply the generative neural network model to generate a recommended immediate action sequence, and transmit the alert data record and recommended action sequence to designated terminal devices.

14. The system according to claim 1, wherein the circuitry is configured to apply a learning and optimization update procedure to the generative neural network model by generating training pairs from historical analysis output data records and corresponding validated measure outcome records, and fine-tuning the model to improve measure proposal relevance scores.

15. The system according to claim 1, wherein the circuitry is configured to enforce a role-based access control policy by associating entity identifier categories with required user role parameters, and restrict the retrieval of analysis output data records and measure proposal data records to the entity identifiers within the permission scope of the requesting terminal device user role.

16. The system according to claim 1, wherein the circuitry is configured to generate a portfolio-level summary data record by aggregating deviation scores and causal factor feature vectors across all monitored entity identifiers, apply the generative neural network model to generate a natural language summary identifying systemic patterns, and transmit the portfolio-level summary data record to terminal devices associated with management user identifiers.

17. The system according to claim 1, wherein the IoT sensor devices are distributed across a manufacturing facility, the multi-source telemetry data comprises current value data and pulse signal data from motor and encoder sensors, the structured records comprise maintenance report data and external condition data, and the entity identifier nodes represent monitored equipment units.

18. A system comprising:
circuitry configured to:
receive, via a communication interface coupled to a packet-switched network, multi-source telemetry data from IoT sensor devices and structured records from external data services, perform sampling rate conversion and noise filtering at an edge gateway, and apply preprocessing comprising outlier removal and natural language processing of text fields;
apply a one-dimensional convolutional neural network and long short-term memory network to generate reconstruction error scores, and apply a graph neural network to propagate entity node feature vectors;
apply a generative neural network model to generate analysis output data records comprising deviation scores and causal factor feature vectors, and generate measure proposal data records by retrieval-augmented generation from a vector database; and
transmit analysis output data records, measure proposal data records, and visualization dashboard data to terminal devices via the communication interface.

19. The system according to claim 18, wherein the circuitry is configured to apply a simulation model to action sequences in measure proposal data records to generate projected outcome trajectories, rank sequences by projected improvement score, and apply a learning optimization update procedure to fine-tune the generative neural network model on validated measure outcome records.

20. A method comprising:
receiving, via a communication interface coupled to a packet-switched network, multi-source telemetry data from IoT sensor devices and structured records from external data service systems, performing sampling rate conversion and noise filtering at an edge gateway, and storing the filtered data in a storage device;
applying preprocessing operations comprising missing value imputation, outlier removal, and natural language processing to generate a preprocessed dataset;
applying a generative neural network model to the preprocessed dataset to generate an analysis output data record comprising deviation scores and causal factor feature vectors;
generating a measure proposal data record by retrieval-augmented generation conditioned on the analysis output data record and reference records retrieved from a vector database; and
transmitting the analysis output data record and the measure proposal data record to terminal devices via the communication interface.
